(19) United States
(12) Patent Application Publication
(10) Pub. No.: US 2026/0156643 A1
(43) Pub. Date: Jun. 4, 2026

(54) METHOD AND APPARATUS FOR INDICATING UNUSED TRANSMISSION OCCASIONS

(71) Applicant: 1FINITY Inc., Kawasaki-shi (JP)

(72) Inventors: Guorong LI, Beijing (CN); Su YI, Beijing (CN); Meiyi JIA, Beijing (CN); Xin WANG, Beijing (CN)

(73) Assignee: 1FINITY Inc., Kawasaki-shi (JP)

(21) Appl. No.: 19/465,664

(22) Filed: Jan. 30, 2026

Related U.S. Application Data
(63) Continuation of application No. PCT/CN2023/111016, filed on Aug. 3, 2023.

(51) Int. Cl. H04W 72/1268; H04L 1/1812; H04W 72/21

(52) U.S. Cl. CPC H04W 72/1268; H04L 1/1812; H04W 72/21

(57) ABSTRACT

An indicating apparatus, configured to indicate unused transmission occasions, configured in a terminal equipment, includes: determining processor circuitry configured to determine an unused transmission occasion at a media access control layer of the terminal equipment; and indicating processor circuitry configured to indicate relevant information on the unused transmission occasion to a physical layer of the terminal equipment via the media access control layer of the terminal equipment; wherein the determining processor circuitry determines whether a transmission occasion in a predetermined number of valid transmission occasions is an unused transmission occasion.

### CROSS-REFERENCE TO RELATED APPLICATION

This application is a continuation application under 35 U.S.C. 111(a) of International Patent Application PCT/CN2023/111016 filed on Aug. 3, 2023, and designated the U.S., the entire contents of which are incorporated herein by reference.

### FIELD

Embodiments of the present disclosure relate to the technical field of communications.

### BACKGROUND

3GPP (3rd Generation Partnership Project) begins to study enhancements for Extended Reality (XR) service in Release 18 (version), and the XR service refers to environment and human-computer interaction of all real and virtual combinations produced by computer technologies and wearable devices. The XR service may include virtual reality (VR) service, augmented reality (AR) service and mixed reality (MR) service.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

In the 3GPP standard, a configured grant (CG) is supported for an uplink. By using the CG, a gNB may allocate uplink resources to a UE, two types of CGs are defined in the 3GPP standard:

Type 1: RRC directly provides a configured uplink grant (including a period).

Type 2: RRC defines a period of a configured uplink grant, while a Physical Downlink Control Channel (PDCCH) addressed to a configured scheduling radio network temporary identifier (CS-RNTI, Configured Scheduling RNTI) may notify and activate the configured uplink grant, or deactivate the configured uplink grant; that is, the PDCCH addressed to the CS-RNTI indicates that the uplink grant may be implicitly reused according to a period defined by RRC until it is deactivated.

For a service that is periodic and has strict latency requirements, such as most of the services generated by XR applications, using the CG is advantageous. However, some XR services have more complex service patterns than CG design. For example, as shown in FIG. 1, a video streaming service may include a periodic Protocol Data Unit burst (PDU burst), rather than a single PDU. This new traffic pattern requires enhancements to legacy CG configurations and processes.

Moreover, 3GPP agrees to support more than one CG PUSCH transmission occasion (CGO) in a period of a single CG PUSCH (Physical Uplink Shared Channel) configuration, and a UE may use UCI (Uplink Control Information) to dynamically indicate an unused CGO to a network device.

The inventor finds that for the unused CGO, currently there is no unified standard for how to determine and how to indicate, as a result, a terminal equipment is unable to report the unused CGO to the network device at an appropriate occasion, thus resulting in resource waste.

For at least one of the above problems or other similar problems, the embodiments of the present disclosure provide a method and an apparatus for indicating unused transmission occasions, so that a network device is informed of unused CGOs, thereby enabling rational allocation of uplink resources and reducing resource waste.

According to an aspect of the embodiments of the present disclosure, an indicating apparatus is provided, configured to indicate unused transmission occasions, configured in a terminal equipment, the apparatus comprising:
a determining unit, configured to determine an unused transmission occasion at a media access control layer of the terminal equipment; and
an indicating unit, configured to indicate relevant information on the unused transmission occasion to a physical layer of the terminal equipment via the media access control layer of the terminal equipment;
wherein in at least one of the following procedures, the determining unit determines the unused transmission occasion and/or the indicating unit indicates relevant information on the unused transmission occasion, the procedures including: an uplink grant receiving procedure, a multiplexing and integration procedure or a logical channel priority processing procedure, an HARQ entity operation procedure, or an HARQ process operation procedure.

According to another aspect of the embodiments of the present disclosure, an apparatus for generating MAC PDUs is provided, configured in a terminal equipment, wherein the apparatus comprises:
a generating unit, configured to generate a MAC PDU for a specific transmission occasion at a MAC layer of the terminal equipment, and
a transmitting unit, configured to transmit the MAC PDU to a network device, and indicate a use state of at least one transmission occasion to the network device,
   wherein the specific transmission occasion includes at least one of the following:
a transmission occasion for which a use state is not indicated, and/or, a transmission occasion determined as unused or a transmission occasion at which a MAC layer determines not to generate a MAC PDU,
a transmission occasion for which a use state has been indicated and the use state is NOT unused, and/or, a transmission occasion determined as unused or a transmission occasion at which a MAC layer determines not to generate a MAC PDU,
a transmission occasion in a first time period,
a transmission occasion in a predetermined number of transmission occasions, or
a transmission occasion after a predetermined number of transmission occasions.

According to another aspect of the embodiments of the present disclosure, an apparatus for processing MAC PDUs is provided, configured in a terminal equipment, wherein the apparatus comprises a generating unit configured to generate MAC PDUs, and not to generate the MAC PDUs when at least one of the following first conditions is satisfied and a second condition is satisfied,
the first conditions comprising:
if a specific transmission occasion is indicated as an unused transmission occasion;
if the specific transmission occasion is determined by MAC as a transmission occasion at which a MAC PDU will not be generated;
if there is no data in any LCG for the specific transmission occasion;
if there is no UTO-UCI to be transmitted;
if the specific transmission occasion is not a first transmission occasion or a last transmission occasion or one of them within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
the second condition comprising at least one of the following:
if there is no aperiodic CSI for a specified PUSCH transmission request;
if the MAC PDU includes zero MAC SDU; or
if the MAC PDU only includes a periodic BSR and there is no data in any LCG to be transmitted, or the MAC PDU only includes a padding BSR.

According to another aspect of the embodiments of the present disclosure, an apparatus for determining End of Data Burst (EoDB) is provided, configured in a terminal equipment, wherein the apparatus comprises:
a determining unit, configured to determine EoDB at a MAC layer of the terminal equipment; and
an indicating unit, configured to indicate relevant information on the EoDB to a physical layer of the terminal equipment at the MAC layer of the terminal equipment;
wherein in at least one of the following procedures, the determining unit determines the EoDB and/or the indicating unit indicates relevant information on the EoDB, the procedures including: an uplink grant receiving procedure, a multiplexing and integration procedure or a logical channel priority processing procedure, an HARQ entity operation procedure, or an HARQ process operation procedure.

According to another aspect of the embodiments of the present disclosure, an apparatus for receiving MAC PDUs is provided, configured in a network device, wherein the apparatus comprises:
a receiving unit, configured to receive a MAC PDU generated by a MAC layer of a terminal equipment for a specific transmission occasion, and receive indication information of a use state of at least one transmission occasion transmitted by the terminal equipment,
wherein the specific transmission occasion includes at least one of the following:
a transmission occasion for which a use state is not indicated, and/or, a transmission occasion determined as unused or a transmission occasion at which a MAC layer of the terminal equipment determines not to generate a MAC PDU,
a transmission occasion for which a use state has been indicated and the use state is NOT unused, and/or, a transmission occasion determined as unused or a transmission occasion at which a MAC layer of the terminal equipment determines not to generate a MAC PDU,
a transmission occasion in a first time period,
a transmission occasion in a predetermined number of transmission occasions, or
a transmission occasion after a predetermined number of transmission occasions.

One of advantageous effects of the embodiments of the present disclosure lies in: according to the embodiments of the present disclosure, during a process of transmitting uplink data, a terminal equipment determines an unused transmission occasion via a MAC layer and indicates relevant information on the unused transmission occasion to a physical layer, thereby the terminal equipment may inform a network device of the relevant information on the unused transmission occasion. As a result, the network device may rationally allocate uplink resources according to the relevant information on the unused transmission occasion, which reduces resource waste.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of an example of an XR service pattern;

FIG. 2 is a schematic diagram of a method for indicating unused transmission occasions in the embodiments of the present disclosure;

FIG. 3 is a schematic diagram of an example of indicating an unused CGO by using UTO-UCI in the embodiments of the present disclosure;

FIG. 4 is a schematic diagram of another example of indicating an unused CGO by using UTO-UCI in the embodiments of the present disclosure;

FIG. 5 is a schematic diagram of a method for generating MAC PDUs in the embodiments of the present disclosure;

FIG. 6 is a schematic diagram of a method for processing MAC PDUs in the embodiments of the present disclosure;

FIG. 7 is a schematic diagram of a method for determining End of Data Burst in the embodiments of the present disclosure;

FIG. 8 is a schematic diagram of a method for receiving MAC PDUs in the embodiments of the present disclosure;

FIG. 9 is a schematic diagram of an example of an indicating apparatus in the embodiments of the present disclosure;

FIG. 10 is a schematic diagram of an example of a generating apparatus in the embodiments of the present disclosure;

FIG. 11 is a schematic diagram of an example of an apparatus for processing MAC PDUs in the embodiments of the present disclosure;

FIG. 12 is a schematic diagram of an example of an apparatus for determining End of Data Burst in the embodiments of the present disclosure;

FIG. 13 is a schematic diagram of an example of a receiving apparatus in the embodiments of the present disclosure;

FIG. 14 is a schematic diagram of a terminal equipment in the embodiments of the present disclosure;

FIG. 15 is a schematic diagram of a network device in the embodiments of the present disclosure.

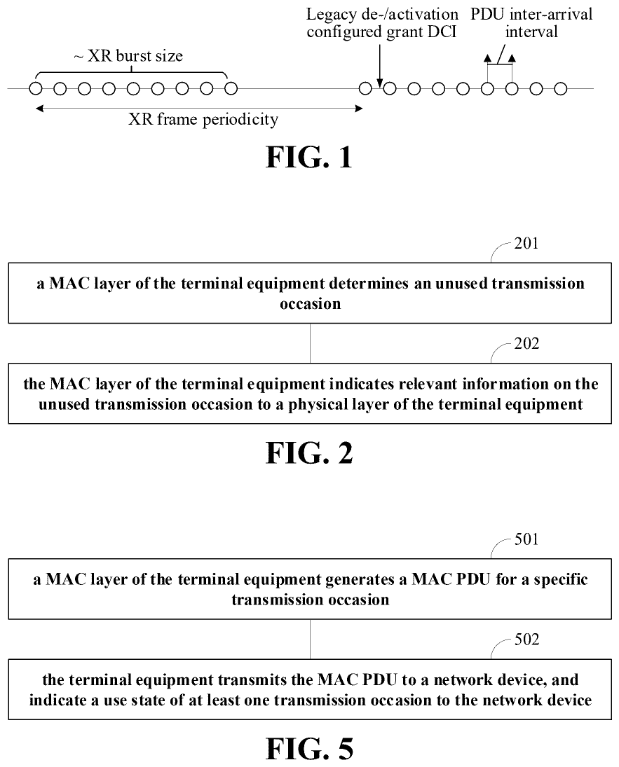

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.), an Integrated Access and Backhaul (IAB) node or an IAB-DU or IAB-donor. And the term “base station” may include their some or all functions, each base station may provide communication coverage to a specific geographic region. The term “cell” may refer to a base station and/or its coverage area, which depends on the context in which this term is used. In a case where there is no confusion, the terms “cell” and “base station” are interchangeable.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT), IAB-MT (Mobile Terminal), a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera, a wearable device and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above, or may further be a device in a core network. The term “a user side” or “a terminal side” or “a terminal equipment side” refers to a side of a user or terminal, may be a UE, and may include one or more terminal equipments as described above. If it is not specifically mentioned herein, “a device” may refer to a network device, or may refer to a terminal equipment.

In the MAC (Media Access Control) specification, regarding triggering of a BSR, there is the following description:

A BSR shall be triggered if any of the following events occur:
UL data, for a logical channel which belongs to an LCG, becomes available to the MAC entity; and either
this UL data belongs to a logical channel with higher priority than the priority of any logical channel
containing available UL data which belong to any LCG; or
none of the logical channels which belong to an LCG contains any available UL data.
in which case the BSR is referred below to as ‘Regular BSR’;
UL resources are allocated and number of padding bits is equal to or larger than the size of the Buffer
Status Report MAC CE plus its subheader, in which case the BSR is referred below to as ‘Padding BSR’;
retxBSR-Timer expires, and at least one of the logical channels which belong to an LCG contains UL data,
in which case the BSR is referred below to as ‘Regular BSR’;
periodicBSR-Timer expires, in which case the BSR is referred below to as ‘Periodic BSR’.
NOTE 1:
When Regular BSR triggering events occur for multiple logical channels simultaneously, each logical channel triggers one separate Regular BSR.

Moreover, in the MAC specification, regarding the content of the BSR, there is the following description:

The fields in the BSR MAC CE are defined as follows:
LCG ID: The Logical Channel Group ID field identifies the group of logical channel(s) whose buffer
status is being reported. The length of the field is 3 bits;
LCGᵢ: For the Long BSR format and Pre-emptive BSR format, this field indicates the presence of the
Buffer Size field for the logical channel group i. The LCGᵢ field set to 1 indicates that the Buffer Size
field for the logical channel group I is reported. The LCGᵢ field set to 0 indicates that the Buffer Size
field for the logical channel group i is not reported. For the Long Truncated BSR format, this field
indicates whether logical channel group i has data available. The LCGᵢ field set to 1 indicates that logical
channel group i has data available. The LCGᵢ field set to 0 indicates that logical channel group i does not
have data available;
Buffer Size: The Buffer Size field identifies the total amount of data available according to the data
volume calculation procedure in TSs 38.322 [3] and 38.323 [4] across all logical channels of a logical
channel group after the MAC PDU has been built (i.e. after the logical channel prioritization procedure,
which may result the value of the Buffer Size field to zero). The amount of data is indicated in number
of bytes. The size of the RLC headers and MAC subheaders are not considered in the buffer size
computation. The length of this field for the Short BSR format and the Short Truncated BSR format is 5
bits. The length of this field for the Long BSR format and the Long Truncated BSR format is 8 bits. The
values for the 5-bit and 8-bit Buffer Size fields are shown in Tables 6.1.3.1-1 and 6.1.3.1-2, respectively.
For the Long BSR format and the Long Truncated BSR format, the Buffer Size fields are included in
ascending order based on the LCGᵢ. For the Long Truncated BSR format the number of Buffer Size
fields included is maximised, while not exceeding the number of padding bits. For the Pre-emptive BSR
format, the Buffer Size field identifies the total amount of the data expected to arrive at the IAB-MT of
the node where the Pre-emptive BSR is triggered and does not include the volume of data currently
available in the IAB-MT. Pre-emptive BSR format is identical to the Long BSR format.

For ease of description, 3GPP uses the word “UTO-UCI” to refer to UCI that provides relevant information on an unused CGO. It is agreed as follows:
for a CG PUSCH configuration, the UTO-UCI is included in each transmitted CG PUSCH.
when a CG PUSCH occasion is indicated as “unused”, a UE is not allowed to transmit a CG PUSCH on the CG PUSCH occasion.
for any other CG PUSCH occasion which is not indicated as “unused”, according to previous regulations, the UE is allowed to transmit or not to transmit a CG PUSCH on the CG PUSCH occasion.
a CG PUSCH occasion that was earlier indicated as “unused” is not allowed to be indicated as “NOT unused” after.
a CG PUSCH occasion that was earlier indicated as “NOT unused” may be indicated as “unused” after.

Embodiments of the present disclosure are described below in conjunction with the drawings and the specific implementations.

In the following description, without causing confusion, “if . . . ” may be replaced by “in a case where” or “when . . . ”; CGO may be replaced by CG PUSCH transmission occasion, CG PTO, CG PUSCH TO, CG PUSCH occasion, PUSCH transmission occasion, PUSCH occasion, CG PUSCH, CG occasion, etc.

### Embodiments of a First Aspect

Embodiments of the present disclosure provide a method for indicating unused transmission occasions, which is described from a terminal equipment side.

FIG. 2 is a schematic diagram of a method for indicating unused transmission occasions in the embodiments of the present disclosure. As shown in FIG. 2, the method includes:
201: a MAC layer of the terminal equipment determines an unused transmission occasion; and
202: the MAC layer of the terminal equipment indicates relevant information on the unused transmission occasion to a physical layer of the terminal equipment;
wherein in at least one of the following procedures, the MAC layer of the terminal equipment determines the unused transmission occasion and/or indicates relevant information on the unused transmission occasion, the procedures including: an uplink grant receiving procedure, a multiplexing and integration procedure or a logical channel priority processing procedure, an HARQ entity operation procedure, or an HARQ process operation procedure.

It should be noted that the above FIG. 2 only schematically describes the embodiments of the present disclosure, but the present disclosure is not limited to this. For example, other some operations can be increased or operations therein may be reduced. Persons skilled in the art may make appropriate modifications according to the above contents, not limited to the records in the above FIG. 2.

According to the above embodiments, during a process of transmitting uplink data, by determining an unused transmission occasion and indicating relevant information on the unused transmission occasion by a MAC layer to a physical layer, the network device may rationally allocate uplink resources, which reduces resource waste.

In some embodiments, “the unused transmission occasion (unused CGO)” refers to a CGO in which there is no uplink data and/or uplink control information is/are transmitted, which may be at least one CGO in a CG periodicity, the specific determination mode will be described below.

In some embodiments, the relevant information on the unused transmission occasion includes:
whether a transmission occasion or a valid transmission occasion within a time period or a CG periodicity is an unused transmission occasion; and/or,
whether a predetermined number of transmission occasions or valid transmission occasions are unused transmission occasions.

In the embodiments of the present disclosure, the valid transmission occasion does not overlap with a DL symbol or an SSB under a TDD configuration.

For example, “the valid transmission occasion” is defined in the standard as follows:

“A configured CG PUSCH is invalid if the CG PUSCH is dropped due to collision with DL symbol(s) indicated by tdd-UL-DL-ConfigurationCommon or tdd-UL-DL-ConfigurationDedicated or SSB. Otherwise, it is valid.”

The following text will not describe it repeatedly.

In the above embodiments, the transmission occasion or the valid transmission occasion is a next transmission occasion after a transmission occasion where the UTO-UCI is located, or is a transmission occasion that starts after an offset value after a transmission occasion where the UTO-UCI is located.

In the above embodiments, a length of the time period or the predetermined number or the offset value is predefined, or is configured by the network device, for example, the network device configures the same via at least one of an RRC setup message, an RRC re-establishment message, an RRC reconfiguration message or an RRC resume message. Embodiments of the present disclosure do not impose limitations thereto.

In some embodiments, the physical layer transmits uplink control information (UTO-UCI) in a used transmission occasion, wherein the uplink control information is used to indicate an unused transmission occasion.

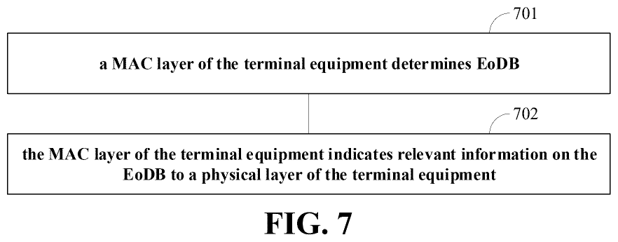

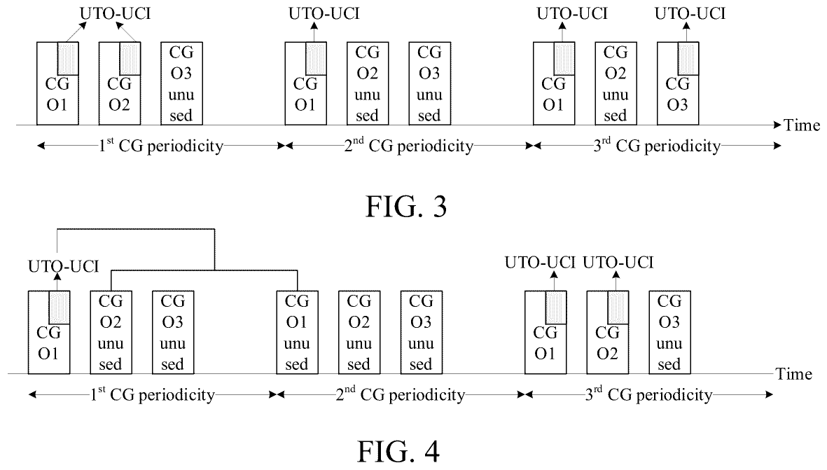

FIG. 3 is a schematic diagram of indicating an unused CGO by using UTO-UCI, showing a process of indicating unused CGOs in a used transmission occasion.

As shown in FIG. 3, three CGOs are configured in each CG periodicity, and in a first CG periodicity, assuming that there is data to be transmitted in a first CGO and a second CGO, no data to be transmitted in a third CGO, and in a second CG periodicity, assuming that there is data to be transmitted in the first CGO, no data to be transmitted in the second CGO and the third CGO, and in a third CG periodicity, assuming that there is data to be transmitted in the first CGO and the third CGO, no data to be transmitted in the second CGO.

In the above example, the CGO in which there is data to be transmitted is called “a used transmission occasion” or called “a not unused transmission occasion”, and in this CGO, UTO-UCI is transmitted, the UTO-UCI may indicate that other CGOs are unused CGO or not unused CGOs. For example, as shown in FIG. 3, in the first CG periodicity, UTO-UCI in the first CGO and UTO-UCI in the second CGO may indicate that the third CGO is an unused transmission occasion, and may further indicate whether a CGO in the second CG periodicity and/or at least one CGO in the third CG periodicity is/are unused; in the second CG periodicity, the UTO-UCI in the first CGO may indicate that the second CGO and the third CGO are unused transmission occasions, and may further indicate whether at least one CGO in the third CG periodicity is unused; and in the third CG periodicity, the UTO-UCI in the first CGO and the UTO-UCI in the third CGO may indicate that the second CGO is an unused transmission occasion, and may further indicate whether subsequent CGOs are unused.

Thereby, by indicating unused transmission occasions via UTO-UCI, the network device is able to timely use radio resources corresponding to the unused transmission occasions indicated by the terminal equipment for uplink transmission of other terminal equipments according to this indication, which reduces waste of radio resources.

In the embodiments of the present disclosure, the MAC layer may determine an unused CGO and/or indicate relevant information on the unused CGO during an uplink data transmission procedure, which are described in the following text respectively.

In some embodiments, the MAC layer of the terminal equipment determines the unused transmission occasion and/or indicates relevant information on the unused transmission occasion, in the uplink grant receiving procedure, which include(s):
the MAC layer of the terminal equipment determines the unused transmission occasion and/or indicates relevant information on the unused transmission occasion after determining that a PUSCH duration of a transmission occasion does not overlap with a PUSCH duration of an uplink grant received in a Random Access Response (RAR) or a PUSCH duration addressed to a temporary cell radio network temporary identifier (C-RNTI) or a PUSCH duration of a message A payload (MSGA payload); or,
the MAC layer of the terminal equipment determines the unused transmission occasion and/or indicates relevant information on the unused transmission occasion after determining that a PUSCH duration of a transmission occasion does not overlap with a PUSCH duration of an uplink grant received on a PDCCH or a PUSCH duration of an uplink grant received in an RAR or a PUSCH duration addressed to a temporary C-RNTI or a PUSCH duration of a MSGA payload; or,
the MAC layer of the terminal equipment determines the unused transmission occasion and/or indicates relevant information on the unused transmission occasion after delivering a transmission occasion or a configured uplink grant and associated HARQ information to an HARQ entity; or,
the MAC layer of the terminal equipment determines the unused transmission occasion and/or indicates relevant information on the unused transmission occasion after considering that an uplink grant corresponding to a transmission occasion is a prioritized uplink grant.

Thereby, by determining or indicating an unused CGO in an uplink grant reception procedure, the terminal equipment may determine the unused CGO earlier and does not need to perform further uplink processing on a CGO that is determined as unused, which reduces the processing complexity of the terminal equipment, and moreover, facilitates the network device to promptly allocate resources corresponding to unused CGOs to other terminal equipments to perform uplink transmission, thereby enhancing a utilization rate of radio resources.

In some embodiments, that the MAC layer of the terminal equipment determines the unused transmission occasion and/or indicates relevant information on the unused transmission occasion, in the multiplexing and integration procedure or the logical channel priority processing procedure, which comprise(s):
the MAC layer of the terminal equipment determines the unused transmission occasion and/or indicates relevant information on the unused transmission occasion after selecting a logical channel for uplink grant transmission of a transmission occasion; or,
the MAC layer of the terminal equipment determines the unused transmission occasion and/or indicates relevant information on the unused transmission occasion after allocating resources for a logical channel; or,
the MAC layer of the terminal equipment determines the unused transmission occasion and/or indicates relevant information on the unused transmission occasion after determining to generate a MAC PDU for an HARQ entity; or,
the MAC layer of the terminal equipment determines the unused transmission occasion and/or indicates relevant information on the unused transmission occasion after determining not to generate a MAC PDU for an HARQ entity; or,
the MAC layer of the terminal equipment determines the unused transmission occasion and/or indicates relevant information on the unused transmission occasion after multiplexing a MAC CE and/or MAC SDU to a MAC PDU.

Thereby, by determining or indicating an unused CGO in the multiplexing and integration procedure or in the logical channel priority processing procedure, required uplink resources can be determined according to a current volume of data to be transmitted. In addition, if a MAC PDU is not generated for a current CGO, a physical layer may be indicated not to transmit UTO-UCI either, which reduces the processing of the physical layer and the occupation of radio resources and facilitates the network device to promptly allocate resources corresponding to unused CGOs to other terminal equipments to perform uplink transmission, thereby enhancing a utilization rate of radio resources.

In some embodiments, that the MAC layer of the terminal equipment determines the unused transmission occasion and/or indicates relevant information on the unused transmission occasion, in the HARQ entity operation procedure, comprises:
the MAC layer of the terminal equipment determines the unused transmission occasion and/or indicates relevant information on the unused transmission occasion after identifying an HARQ process associated with an uplink grant of a CGO; or,
the MAC layer of the terminal equipment determines the unused transmission occasion and/or indicates relevant information on the unused transmission occasion after a MAC PDU is obtained; or,
the MAC layer of the terminal equipment determines the unused transmission occasion and/or indicates relevant information on the unused transmission occasion after delivering a MAC PDU, an uplink grant, and HARQ information to an identified HARQ process; or,
the MAC layer of the terminal equipment determines the unused transmission occasion and/or indicates relevant information on the unused transmission occasion after indicating an identified HARQ process to trigger a new transmission; or,
the MAC layer of the terminal equipment determines the unused transmission occasion and/or indicates relevant information on the unused transmission occasion after starting or restarting configuredGrantTimer.

Thereby, by determining or indicating an unused CGO in the HARQ entity operation procedure, required uplink resources can be determined according to a current volume of data to be transmitted. In addition, only when it is determined that there is uplink PUSCH transmission in a current CGO, relevant information on the unused CGO is indicated to a physical layer, so as to reduce unnecessary processing of the physical layer and the occupation of radio resources and facilitates the network device to promptly allocate resources corresponding to unused CGOs to other terminal equipments to perform uplink transmission, thereby enhancing a utilization rate of radio resources.

In some embodiments, that the MAC layer of the terminal equipment determines the unused transmission occasion and/or indicates relevant information on the unused transmission occasion, in the HARQ process operation procedure, comprises:
the MAC layer of the terminal equipment determines the unused transmission occasion and/or indicates relevant information on the unused transmission occasion after an HARQ process generates a transmission; or,
the MAC layer of the terminal equipment determines the unused transmission occasion and/or indicates relevant information on the unused transmission occasion after indicating a physical layer to generate a transmission according to an uplink grant.

Thereby, by determining or indicating an unused CGO in the HARQ process operation procedure, required uplink resources can be determined according to a current volume of data to be transmitted, which facilitates a physical layer to indicate the latest or most real-time unused CGOs in UTO-UCI and facilitates the network device to promptly allocate resources corresponding to unused CGOs to other terminal equipments to perform uplink transmission, thereby enhancing a utilization rate of radio resources.

The above respectively describes determining or indicating an unused CGO in each process of uplink grant, and the following provides a detailed description of a method for determining an unused CGO at a MAC layer.

In some embodiments, that the MAC layer of the terminal equipment determines an unused transmission occasion comprises at least one of the following:
the MAC layer of the terminal equipment determines an unused transmission occasion, for each transmission occasion;
the MAC layer of the terminal equipment determines an unused transmission occasion for all transmission occasions within a configured grant (CG) periodicity or a time period or in a predetermined number of transmission occasions; or
the MAC layer of the terminal equipment determines an unused transmission occasion for partial transmission occasions within a CG periodicity or a time period or in a predetermined number of transmission occasions.

The following text provides descriptions respectively.

In some embodiments, that the MAC layer of the terminal equipment determines an unused transmission occasion, for each transmission occasion, comprises:
the MAC layer of the terminal equipment determines whether at least one transmission occasion is an unused transmission occasion according to a current buffer size and/or traffic pattern.

For example, the MAC layer determines a use state of at least one subsequent transmission occasion for each transmission occasion or before each transmission occasion or T1 time (T1 is greater than or equal to 0) according to a current buffer size and/or traffic pattern, for example determines whether a CGO or a valid CGO in a period of time or a CG periodicity is unused, the period of time may be X milliseconds or N CG periodicities, where X and N are positive integers, and/or, determines whether M CGOs or M valid CGOs are unused, where M is a positive integer.

For example, as shown in FIG. 3, for CGO1 in the first CG periodicity, the MAC determines e.g. whether three CGOs are unused according to e.g. information such as a buffer size and a service pattern at a current (before the CGO1 or T1 time (T1 is greater than or equal to 0)), for example determines CGO1 and CGO2 as NOT unused and CGO3 as unused; and for CGO2 in the first CG periodicity, determines e.g. whether three CGOs are unused according to information such as buffer size and a service pattern at a current (before CGO2), for example determines CGO2 as NOT unused, CGO3 as unused, and CGO1 in the second CG periodicity as NOT unused, etc.

In addition, in some embodiments, the MAC layer may compare a buffer size at current or before T1 time (T1 is greater than or equal to 0) and a data volume that a CGO is able to transmit, to determine how many CGOs are needed for data transmission, or the MAC layer may speculate how many or which CGOs for data transmission are needed for data arriving in the future, according to a traffic pattern (such as a period or offset of service arrival or a size of a data packet, etc.). For example, the MAC layer determines an unused CGO based on a model (pattern) of an XR service and/or a current data volume of L2 (or a data volume in the buffer of a PDCP and/or RLC, or a data volume in a logical channel queue, etc.) and/or a payload size of PDUs in PDU sets and/or a size of data burst, etc, for example similar logical channel priority processing procedure or multiplexing and assembly procedure or a procedure for obtaining MAC PDUs may be executed in advance to determine how many CGOs are needed to transmit data in the current buffer, or which CGOs will be used to transmit data arriving in the future according to a period and/or offset time of the data arriving in the future. The following will not provide a repeated description in this regard.

In the above embodiments, the MAC layer of the terminal equipment notifies the physical layer of the relevant information on the unused transmission occasion for each transmission occasion; or, for a transmission occasion that is determined to be unused, the MAC layer of the terminal equipment does not notify the physical layer of the relevant information on the unused transmission occasion.

Thereby, by determining or indicating an unused CGO for each transmission occasion, the network device is able to know in real time a use state of a subsequent CGO, thereby promptly allocating an uplink resource corresponding to the unused CGO to other terminal equipments, so as to improve a utilization rate of radio resources.

In some embodiments, that the MAC layer of the terminal equipment determines an unused transmission occasion for all transmission occasions within a CG periodicity or a time period or in a predetermined number of transmission occasions, comprises:
the MAC layer of the terminal equipment determines whether at least one transmission occasion is an unused transmission occasion according to a buffer size and/or traffic pattern.

For example, for transmission occasions within a CG periodicity or a period of time or a predetermined number of transmission occasions, the MAC layer determines a use state of at least one subsequent transmission occasion according to a current buffer size and/or traffic pattern, for example determines whether a CGO or a valid CGO in a period of time or a CG periodicity is unused, the period of time may be X milliseconds or N CG periodicities, where X and N are positive integers, and/or, determines whether M CGOs or M valid CGOs are unused, where M is a positive integer.

For example, as shown in FIG. 3, in a first CG periodicity, the MAC layer may determine or predict whether M CGOs in the first CG periodicity or a second CG periodicity or subsequent other CG periodicities are unused CGOs according to a buffer size and/or traffic pattern before the first CG periodicity or in a T1 time (T1 is greater than or equal to 0) before the first CG periodicity, where M is a positive integer, and/or, determine whether all CGOs within a period of time are unused CGOs, and/or, determine whether e.g. 5 CGOs are unused CGOs.

For another example, within a period of time, the MAC layer determines or predicts whether M transmission occasions within the period of time or M transmission occasions after the period of time are unused CGOs according to a buffer size and/or traffic pattern before the period of time or in a T1 time (T1 is greater than or equal to 0) before the period of time, where M is a positive integer.

For a further example, in a predetermined number of transmission occasions, the MAC layer determines or predicts whether the predetermined number of transmission occasions or M transmission occasions after the predetermined number of transmission occasions are unused CGOs according to a buffer size and/or traffic pattern before the predetermined number of transmission occasions or in a T1 time (T1 is greater than or equal to 0) before the predetermined number of transmission occasions, where M is a positive integer.

In the above embodiments, that the MAC layer of the terminal equipment indicates relevant information on the unused transmission occasion to a physical layer of the terminal equipment, comprises:
the MAC layer of the terminal equipment notifies at one time the physical layer of the relevant information on the unused transmission occasion.

In the above embodiments, the MAC layer of the terminal equipment notifies at one time the physical layer of the relevant information on the unused transmission occasion within a CG periodicity or a time period or before a predetermined number of transmission occasions.

Thereby, by notifying at one time the relevant information on all unused transmission occasions, the number of times for the terminal equipment to determine or indicate unused transmission occasions is reduced, so as to alleviate burden and complexity of the terminal equipment, thereby reducing power consumption of the terminal equipment.

In some embodiments, that the MAC layer of the terminal equipment determines an unused transmission occasion for partial transmission occasions within a CG periodicity or a time period or in a predetermined number of transmission occasions, comprises:
when new data arrives, for next transmission occasions, the MAC layer of the terminal equipment determines whether at least one transmission occasion is an unused transmission occasion, and/or, for specific transmission occasions within a CG periodicity or a time period or in a predetermined number of transmission occasions, the MAC layer of the terminal equipment determines whether at least one transmission occasion is an unused transmission occasion.

For example, when new data arrives a logical channel and/or a logical channel group, for a next CGO or before the next CGO or before the time T1 of the next CGO (T1 is greater than or equal to 0), the MAC layer determines whether at least one transmission occasion is an unused transmission occasion according to a current buffer size and/or traffic pattern.

For another example, for specific transmission occasions within a CG periodicity or a time period or in a predetermined number of transmission occasions, the MAC layer determines whether at least one transmission occasion is an unused transmission occasion according to a buffer size and/or traffic pattern at current or before time T1 (T1 is greater than or equal to 0), the specific transmission occasion may be e.g. a first CGO or a Kth CGO (K is an integer greater than 1) or a last CGO within a CG periodicity or a time period or in a predetermined number of transmission occasions, or the Jth to Lth CGOs (J and L are positive integers, L is greater than J), etc.

In the above examples, determining whether at least one transmission occasion is an unused transmission occasion may be to determine whether a CGO or a valid CGO in a certain period of time or a certain CG periodicity is unused, the period of time may be X milliseconds or N CG periodicities, where X and N are positive integers, and/or, to determine whether M CGOs or M valid CGOs are unused, where M is a positive integer.

In the above embodiments, that the MAC layer of the terminal equipment indicates relevant information on the unused transmission occasion to a physical layer of the terminal equipment, comprises:
after the unused transmission occasion is determined, the MAC layer of the terminal equipment notifies the physical layer of the relevant information on the unused transmission occasion.

Thereby, the number of times for the terminal equipment to determine or indicate unused transmission occasions is reduced, so as to further alleviate burden and complexity of the terminal equipment, thereby reducing power consumption of the terminal equipment.

In the above embodiments, the method further includes:
the MAC layer of the terminal equipment does not transmit UTO-UCI in an unused transmission occasion.

Thereby, burden and complexity of the terminal equipment is further alleviated, thereby reducing power consumption of the terminal equipment and occupation of radio resources.

In some embodiments, that the MAC layer of the terminal equipment determines an unused transmission occasion, further comprises:
the terminal equipment determines whether a transmission occasion or a valid transmission occasion within a time period or a CG periodicity is an unused transmission occasion; and/or,
the terminal equipment determines whether a predetermined number of transmission occasions or valid transmission occasions are unused transmission occasions.

In the above embodiments, the transmission occasion or the valid transmission occasion includes a next transmission occasion after a transmission occasion where the UTO-UCI is located, or is a transmission occasion that starts after an offset value after a transmission occasion where the UTO-UCI is located. The “valid transmission occasion” has been described in the above embodiments, for its specific explanation, the preceding description may be referred to, it is not repeated here.

In the above embodiments, a length of the time period or the predetermined number or the offset value is predefined, or is configured by a network. Embodiments of the present disclosure do not impose limitations thereto.

The above text describes relevant information on indicating unused CGOs via UTO-UCI. In some situations, MAC PDUs may not be generated for certain specific CGOs, thereby it is impossible to indicate the relevant information on unused CGOs by transmitting the UTO-UCI. Therefore, MAC PDUs need to be generated for these specific CGOs to indicate the relevant information. The following text makes descriptions in this regard.

In some embodiments, for a specific transmission occasion, the MAC layer of the terminal equipment generates a MAC PDU, the specific transmission occasion including at least one of the following:
a transmission occasion for which a use state is not indicated, and/or, a transmission occasion determined as unused or a transmission occasion at which a MAC layer determines not to generate a MAC PDU,
a transmission occasion for which a use state has been indicated and the use state is NOT unused, and/or, a transmission occasion determined as unused or a transmission occasion at which a MAC layer determines not to generate a MAC PDU,
a transmission occasion in a first time period,
a transmission occasion in a predetermined number of transmission occasions, or
a transmission occasion after a predetermined number of transmission occasions.

Thereby, by generating MAC PDUs for these specific CGOs, so as to indicate relevant information on unused CGOs via indication information (UTO-UCI) transmitted in a CG PUSCH where the MAC PDUs are located, facilitating a network device to timely obtain the relevant information on unused CGOs to allocate relevant resources to other terminal equipments for performing uplink transmission, thereby enhancing a utilization rate of radio resources.

In the above embodiments, the transmission occasion whose use state is not indicated refers to that a current state of the transmission occasion is neither indicated as unused nor as NOT unused, moreover the transmission occasion may be indicated as unused or NOT unused at a certain moment in the future.

In the above embodiments, the transmission occasion in the first time period is a first transmission occasion or a last transmission occasion or one of transmission occasions in the first time period.

In the above embodiments, the transmission occasion in the predetermined number of transmission occasions is a first transmission occasion, a last transmission occasion or one of transmission occasions in the predetermined number of transmission occasions.

In the above embodiments, the transmission occasion after the predetermined number of transmission occasions is a first transmission occasion after the predetermined number of transmission occasions or a first transmission occasion after a first number of offsets after the predetermined number of transmission occasions.

In the above embodiments, the first number of offsets is predefined, or is configured by a network.

In the above embodiments, the first time period is one or more CG periodicities, or the first time period is a predefined time period or a time period configured by a network device, and the predetermined number is predefined, or is configured by a network.

In the above embodiments, the MAC PDU generated by the MAC layer of the terminal equipment is at least one of the following:
a MAC PDU including a padding bit;
a MAC PDU including a regular BSR; or
a MAC PDU including a padding BSR.

The following provides a detailed description of conditions for not generating a MAC PDU.

In the above embodiments, the MAC layer of the terminal equipment does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions in a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

Each of the above embodiments is only illustrative for the embodiments of the present disclosure, but the present disclosure is not limited thereto, appropriate modifications may be further made based on the above each embodiment. For example, each of the above embodiments may be used individually, or one or more of the above embodiments may be combined.

According to the method in the embodiments of the present disclosure, during a process of transmitting uplink data, a terminal equipment determines an unused transmission occasion via a MAC layer and indicates relevant information on the unused transmission occasion to a physical layer, thereby the terminal equipment may inform a network device of the relevant information on the unused transmission occasion. As a result, the network device may rationally allocate uplink resources according to the relevant information on the unused transmission occasion, which reduces resource waste.

### Embodiments of a Second Aspect

Inventor finds that in some situations, at moments of several CGOs of one CG periodicity, a UE may not have uplink data to be transmitted to a network, or in the UE's buffer or logical channel queue, there is no data to be transmitted, the UE will not generate MAC PDUs for these several CGOs, FIG. 4 is a schematic diagram of this situation. As shown in FIG. 4, assuming that at CGO2 and CGO3 in the first CG periodicity and three CGOs in the second CG periodicity, there may have no uplink data or uplink PUSCH to be transmitted. However, in UTO-UCI transmitted by the UE in a CGO (such as CGO1 in the first CG period) before these CGOs, all subsequent unused CGOs may not be indicated, or assuming that the UE has not transmitted UTO-UCI before, a network device may not be aware that there are still some CGOs that are unused, for example assuming that in the first CG periodicity in FIG. 4, UTO-UCI in CGO1 indicates whether the subsequent three CGOs (i.e., CGO2 and CGO3 in the first CG periodicity and CGO1 in the second CG period) are unused, and does not indicate whether two CGOs (i.e., CGO2 and CGO3 in the second CG period) after these three CGOs are unused, while none of these five CGOs have CG PUSCH to be transmitted, thus none of them transmit the UTO-UCI. As a result, the network device (gNB) does not know whether CGO2 and CGO3 in the second CG periodicity are unused, thereby the network device cannot promptly allocate resources of these two CGOs to other UEs, thus leading to resource waste.

To solve the above technical problem, the embodiments of the present disclosure provide a method for generating MAC PDUs to reduce resource waste.

The method for generating MAC PDUs is described from a terminal equipment side. FIG. 5 is a schematic diagram of a method for generating MAC PDUs in the embodiments of the present disclosure. As shown in FIG. 5, the method includes:
501: a MAC layer of the terminal equipment generates a MAC PDU for a specific transmission occasion, and
502: the terminal equipment transmits the MAC PDU to a network device, and indicate a use state of at least one transmission occasion to the network device, wherein the specific transmission occasion includes at least one of the following:
a transmission occasion for which a use state is not indicated, and/or, a transmission occasion determined as unused or a transmission occasion at which a MAC layer determines not to generate a MAC PDU,
a transmission occasion for which a use state has been indicated and the use state is NOT unused, and/or, a transmission occasion determined as unused or a transmission occasion at which
a MAC layer determines not to generate a MAC PDU,
a transmission occasion in a first time period,
a transmission occasion in a predetermined number of transmission occasions, or
a transmission occasion after a predetermined number of transmission occasions.

It should be noted that the above FIG. 5 only schematically describes the embodiments of the present disclosure, but the present disclosure is not limited to this. For example, other some operations can be increased or operations therein may be reduced. Persons skilled in the art may make appropriate modifications according to the above contents, not limited to the records in the above FIG. 5.

According to the embodiments of the present disclosure, by generating MAC PDUs for specific CGOs to indicate a use state of at least one CGO, the network device is able to promptly obtain relevant information on unused CGOs, thereby rationally allocating resources and reducing resource waste.

For the use state of at least one CGO, Embodiment 1 may be referred to, and no more description is provided here.

In some embodiments, the terminal equipment indicates a use state of the at least one CGO to the network device via UTO-UCI, the UTO-UCI being transmitted in a PUSCH corresponding to a specific transmission occasion, that is, the UTO-UCI is transmitted in a PUSCH resource corresponding to a CGO where the generated MAC PDU is located.

In some embodiments, the transmission occasion in the first time period is a first transmission occasion or a last transmission occasion or one of transmission occasions in the first time period.

In some embodiments, the transmission occasion in the predetermined number of transmission occasions is a first transmission occasion, a last transmission occasion or one of transmission occasions in the predetermined number of transmission occasions.

In some embodiments, the transmission occasion after the predetermined number of transmission occasions is a first transmission occasion after the predetermined number of transmission occasions or a first transmission occasion after a first number of offsets after the predetermined number of transmission occasions.

In the above embodiments, the first number of offsets is predefined, or is configured by a network.

In some embodiments, the first time period is one or more CG periodicities, or the first time period is a predefined time period or a time period configured by a network device, and the predetermined number is predefined, or is configured by a network.

In some embodiments, the MAC PDU generated by the MAC layer of the terminal equipment is at least one of the following:
a MAC PDU including a padding bit;
a MAC PDU including a regular BSR; or
a MAC PDU including a padding BSR.

In some embodiments, the MAC layer of the terminal equipment does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

For example, for “if the specific transmission occasion is not a first transmission occasion after the predetermined number of transmission occasions or a first transmission occasion after a first offset value after the predetermined number of transmission occasions” in the first conditions, the content indicated by the underline below may be added to the Standard to correspond to it:

```
1> else if the MAC entity is configured with skipUplinkTxDynamic with value true and the grant indicated
  to the HARQ entity was addressed to a C-RNTI, or the grant indicated to the HARQ entity is a
  configured uplink grant:
```

| 2> | if there is no aperiodic CSI requested for this PUSCH transmission | |
|---|---|---|
| | as specified in TS 38.212 [9]; | |
| | and | |
| 2> | if the MAC PDU includes zero MAC SDUs; and | |
| 2> | if the MAC PDU includes only the periodic BSR and there is no | |
| | data available for any LCG, or the | |
| | MAC PDU includes only the padding BSR; and | |
| 2> | if the PUSCH transmission occasion is not the first CG PUSCH | |
| | transmission occasion in a CG period: | |
| | 3> | not generate a MAC PDU for the HARQ entity. |

As for other conditions in the first conditions, similar define may be made in the Standard, and will not be described one by one here.

According to the above embodiments, by generating MAC PDUs for specific CGOs to indicate a use state of at least one CGO via UTO-UCI, the network device is able to promptly obtain relevant information on unused CGOs, thereby allocate unused resources to other terminal equipments to perform uplink transmission, reducing the waste of radio resources.

### Embodiments of a Third Aspect

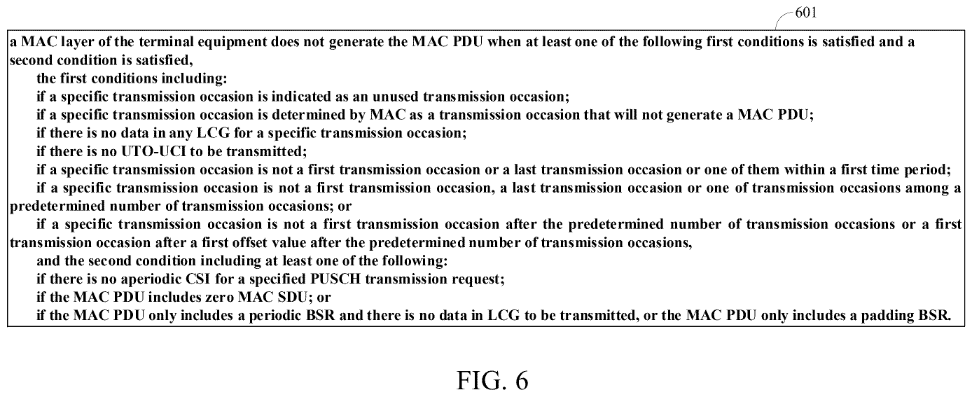

Embodiments of the present disclosure further provide a method for processing MAC PDUs, applied to a terminal equipment. FIG. 6 is a schematic diagram of a method for processing MAC PDUs in the embodiments of the present disclosure. As shown in FIG. 6, the method includes:
601: a MAC layer of the terminal equipment does not generate the MAC PDU when at least one of the following first conditions is satisfied and a second condition is satisfied, the first conditions including:
if a specific transmission occasion is indicated as an unused transmission occasion;
if a specific transmission occasion is determined by MAC as a transmission occasion that will not generate a MAC PDU;
if there is no data in any LCG for a specific transmission occasion;
if there is no UTO-UCI to be transmitted;
if a specific transmission occasion is not a first transmission occasion or a last transmission occasion or one of them within a first time period;
if a specific transmission occasion is not a first transmission occasion, a last transmission occasion or one of transmission occasions among a predetermined number of transmission occasions; or
if a specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG to be transmitted, or the MAC PDU only includes a padding BSR.

It should be noted that the above FIG. 6 only schematically describes the embodiments of the present disclosure, but the present disclosure is not limited to this. For example, other some operations can be increased or operations therein may be reduced. Persons skilled in the art may make appropriate modifications according to the above contents, not limited to the records in the above FIG. 6.

In the above embodiments, the first time period is one or more CG periodicities, or the first time period is a predefined time period or a time period configured by a network device, and the predetermined number is predefined, or is configured by a network.

According to the method for processing MAC PDUs in the embodiments of the present disclosure, for CGOs determined as unused, a MAC PDU is not generated, such that uplink transmission is avoided to be transmitted by a physical layer, thereby reducing waste of radio resources.

The method for determining unused CGOs in the embodiments of the present disclosure may be used to determine End of Data Burst (EoDB). That is to say, determining an unused CGO is equivalent to determining EoDB. Implementations for determining the unused CGO and implementations for determining the EoDB in the embodiments of the present disclosure may be interchangeable.

Thereby, the embodiments of the present disclosure further provide a method for determining End of Data Burst (EoDB), applied to a terminal equipment. Implementations of the method for determining End of Data Burst in the embodiments of the present disclosure have the same contents as the method described in the embodiments of the first aspect, the same contents are combined here.

FIG. 7 is a schematic diagram of a method for determining End of Data Burst in the embodiments of the present disclosure. As shown in FIG. 7, the method includes:
701: a MAC layer of the terminal equipment determines EoDB; and
702: the MAC layer of the terminal equipment indicates relevant information on the EoDB to a physical layer of the terminal equipment;
wherein, the MAC layer of the terminal equipment determines the EoDB and/or indicates relevant information on the EoDB in at least one of the following procedures, the processes including: an uplink grant receiving procedure, a multiplexing and integration procedure or a logical channel priority processing procedure, an HARQ entity operation procedure, or an HARQ process operation procedure.

In some embodiments, the physical layer of the terminal equipment transmits uplink control information to the network device, wherein the uplink control information is used to indicate the EoDB.

According to the method for determining End of Data Burst in the embodiments of the present disclosure, the network device is able to rationally allocate uplink resources, which reduces resource waste.

### Embodiments of a Fourth Aspect

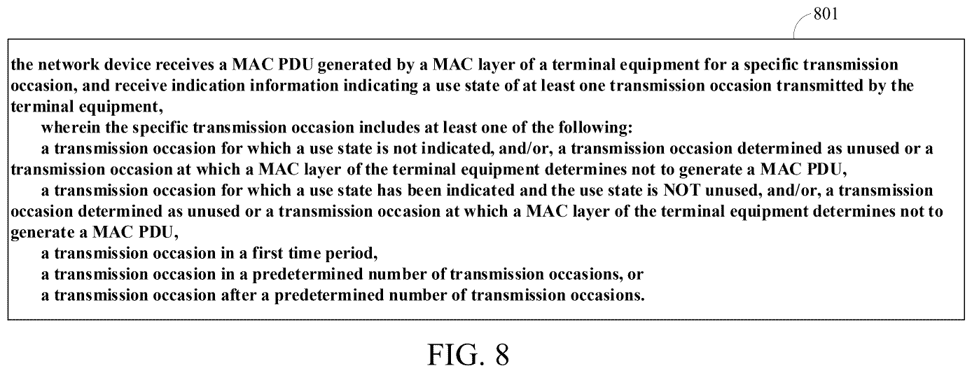

Embodiments of the present disclosure further provide a method for receiving MAC PDUs, applied to a network device, the contents same as the embodiments of the first to third aspects are not repeated. FIG. 8 is a schematic diagram of a method for receiving MAC PDUs in the embodiments of the present disclosure. As shown in FIG. 8, the method includes:
801: the network device receives a MAC PDU generated by a MAC layer of a terminal equipment for a specific transmission occasion, and receive indication information indicating a use state of at least one transmission occasion transmitted by the terminal equipment,
wherein the specific transmission occasion includes at least one of the following:
a transmission occasion for which a use state is not indicated, and/or, a transmission occasion determined as unused or a transmission occasion at which a MAC layer of the terminal equipment determines not to generate a MAC PDU,
a transmission occasion for which a use state has been indicated and the use state is NOT unused, and/or, a transmission occasion determined as unused or a transmission occasion at which a MAC layer of the terminal equipment determines not to generate a MAC PDU,
a transmission occasion in a first time period,
a transmission occasion in a predetermined number of transmission occasions, or
a transmission occasion after a predetermined number of transmission occasions.

It should be noted that the above FIG. 8 only schematically describes the embodiments of the present disclosure, but the present disclosure is not limited to this. For example, other some operations can be increased or operations therein may be reduced. Persons skilled in the art may make appropriate modifications according to the above contents, not limited to the records in the above FIG. 8.

According to the embodiments of the present disclosure, by receiving MAC PDUs generated by a terminal equipment for a specific transmission occasion and indication information indicating a use state of at least one CGO, the network device is able to promptly allocate uplink resources corresponding to unused CGOs to other terminal equipments, thereby improving a utilization rate of radio resources.

In some embodiments, the indication information transmitted by the terminal equipment is UTO-UCI. That is, the terminal equipment indicates a use state of the at least one CGO to the network device via UTO-UCI, the UTO-UCI being transmitted in a PUSCH corresponding to a specific transmission occasion, that is, the UTO-UCI is transmitted in a PUSCH resource corresponding to a CGO where the generated MAC PDU is located, thereby the network device receives the indication information in corresponding resources.

In some embodiments, the transmission occasion in the first time period is a first transmission occasion or a last transmission occasion or one of transmission occasions in the first time period.

In some embodiments, the transmission occasion in the predetermined number of transmission occasions is a first transmission occasion, a last transmission occasion or one of transmission occasions in the predetermined number of transmission occasions.

In some embodiments, the transmission occasion after the predetermined number of transmission occasions is a first transmission occasion after the predetermined number of transmission occasions or a first transmission occasion after a first number of offsets after the predetermined number of transmission occasions.

In some embodiments, the first number of offsets is predefined, or is configured by a network.

In some embodiments, the first time period is one or more CG periodicities, or the first time period is a predefined time period or a time period configured by a network device, and the predetermined number is predefined, or is configured by a network. Embodiments of the present disclosure do not impose limitations thereto.

In some embodiments, the MAC PDU generated by the MAC layer of the terminal equipment is at least one of the following:
a MAC PDU including a padding bit;
a MAC PDU including a regular BSR; or
a MAC PDU including a padding BSR.

In some embodiments, the MAC layer of the terminal equipment does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

According to the method in the embodiments of the present disclosure, by receiving MAC PDUs generated by a terminal equipment for a specific transmission occasion and indication information indicating a use state of at least one CGO, the network device is able to promptly allocate uplink resources corresponding to unused CGOs to other terminal equipments, thereby improving a utilization rate of radio resources.

### Embodiments of a Fifth Aspect

Embodiments of the present disclosure provide an indicating apparatus, configured to indicate unused transmission occasions. The apparatus may, for example, be a terminal equipment, or may be one or more parts or components configured in the terminal equipment. The apparatus in the embodiments of the present disclosure corresponds to the method in the embodiments of the first aspect, the contents same as those in the embodiments of the first aspect are not repeated.

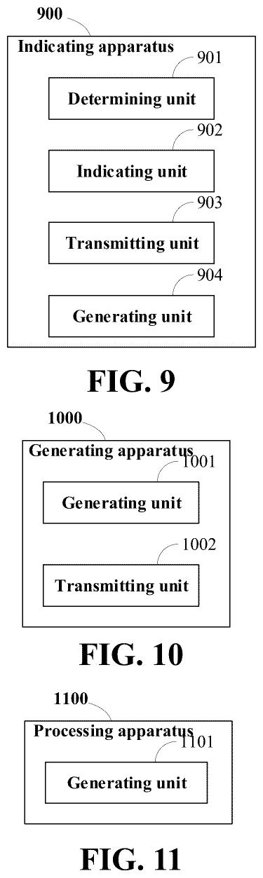

FIG. 9 is a schematic diagram of an example of an indicating apparatus in the embodiments of the present disclosure. As shown in FIG. 9, the indicating apparatus 900 in the embodiments of the present disclosure comprises a determining unit 901 and an indicating unit 902, the determining unit 901 determining an unused transmission occasion at a MAC layer of the terminal equipment; and the indicating unit 902 indicating relevant information on the unused transmission occasion to a physical layer of the terminal equipment via the MAC layer of the terminal equipment; wherein the determining unit 901 determines the unused transmission occasion and/or the indicating unit 902 indicates relevant information on the unused transmission occasion in at least one of the following procedures, the procedures including: an uplink grant receiving procedure, a multiplexing and integration procedure or a logical channel priority processing procedure, an HARQ entity operation procedure, or an HARQ process operation procedure.

In some embodiments, the indicating unit 902 further indicates the physical layer to transmit uplink control information (UTO-UCI) in a not-unused transmission occasion, wherein the uplink control information is used to indicate unused transmission occasions.

In some embodiments, in the uplink grant receiving procedure, the determining unit 901 determines the unused transmission occasion and/or the indicating unit 902 indicates relevant information on the unused transmission occasion, which include(s):
the MAC layer of the terminal equipment determines the unused transmission occasion and/or indicates relevant information on the unused transmission occasion after determining that a PUSCH duration of a transmission occasion does not overlap with a PUSCH duration of an uplink grant received in an RAR or a PUSCH duration addressed to a temporary C-RNTI or a PUSCH duration of a MSGA payload; or,
the MAC layer of the terminal equipment determines the unused transmission occasion and/or indicates relevant information on the unused transmission occasion after determining that a PUSCH duration of a transmission occasion does not overlap with a PUSCH duration of an uplink grant received on a PDCCH or a PUSCH duration of an uplink grant received in an RAR or a PUSCH duration addressed to a temporary C-RNTI or a PUSCH duration of a MSGA payload; or,
the MAC layer of the terminal equipment determines the unused transmission occasion and/or indicates relevant information on the unused transmission occasion after transmitting a transmission occasion or a configured uplink grant and associated HARQ information to an HARQ entity; or,
the MAC layer of the terminal equipment determines the unused transmission occasion and/or indicates relevant information on the unused transmission occasion after considering that an uplink grant corresponding to a transmission occasion is a prioritized uplink grant.

In some embodiments, in the multiplexing and integration procedure or the logical channel priority processing procedure at the MAC layer of the terminal equipment, the determining unit 901 determines the unused transmission occasion and/or the indicating unit 902 indicates relevant information on the unused transmission occasion, which include(s):
the MAC layer of the terminal equipment determines the unused transmission occasion and/or indicates relevant information on the unused transmission occasion after selecting a logical channel for uplink grant transmission of a transmission occasion; or,
the MAC layer of the terminal equipment determines the unused transmission occasion and/or indicates relevant information on the unused transmission occasion after allocating resources for a logical channel; or,
the MAC layer of the terminal equipment determines the unused transmission occasion and/or indicates relevant information on the unused transmission occasion after determining to generate a MAC PDU for an HARQ entity; or,
the MAC layer of the terminal equipment determines the unused transmission occasion and/or indicates relevant information on the unused transmission occasion after determining not to generate a MAC PDU for an HARQ entity; or,
the MAC layer of the terminal equipment determines the unused transmission occasion and/or indicates relevant information on the unused transmission occasion after multiplexing a MAC CE and/or MAC SDU to a MAC PDU.

In some embodiments, in the HARQ entity operation procedure, the determining unit 901 determines the unused transmission occasion and/or the indicating unit 902 indicates relevant information on the unused transmission occasion, which include(s):
the MAC layer of the terminal equipment determines the unused transmission occasion and/or indicates relevant information on the unused transmission occasion after identifying an HARQ process associated with an uplink grant of a CGO; or,
the MAC layer of the terminal equipment determines the unused transmission occasion and/or indicates relevant information on the unused transmission occasion after a MAC PDU is obtained; or,
the MAC layer of the terminal equipment determines the unused transmission occasion and/or indicates relevant information on the unused transmission occasion after delivering a MAC PDU, an uplink grant and HARQ information to an identified HARQ process; or,
the MAC layer of the terminal equipment determines the unused transmission occasion and/or indicates relevant information on the unused transmission occasion after indicating an identified HARQ process to trigger a new transmission; or,
the MAC layer of the terminal equipment determines the unused transmission occasion and/or indicates relevant information on the unused transmission occasion after starting or restarting configuredGrantTimer.

In some embodiments, in the HARQ process operation procedure, the determining unit 901 determines the unused transmission occasion and/or the indicating unit 902 indicates relevant information on the unused transmission occasion, which include(s):
the MAC layer of the terminal equipment determines the unused transmission occasion and/or indicates relevant information on the unused transmission occasion after an HARQ process generates a transmission; or,
the MAC layer of the terminal equipment determines the unused transmission occasion and/or indicates relevant information on the unused transmission occasion after indicating a physical layer to generate a transmission according to an uplink grant.

In some embodiments, the determining unit 901 determines an unused transmission occasion, which comprises at least one of the following:
determining an unused transmission occasion for each transmission occasion;
determining an unused transmission occasion for all transmission occasions within a configured grant (CG) periodicity or a time period or in a predetermined number of transmission occasions; or
determining an unused transmission occasion for partial transmission occasions within a CG periodicity or a time period or in a predetermined number of transmission occasions.

In some embodiments, the determining unit 901 determines an unused transmission occasion, for each transmission occasion, which comprises:
the determining unit 901 determines whether at least one transmission occasion is an unused transmission occasion according to a current buffer size and/or traffic pattern.

In some embodiments, the indicating unit 902 indicates relevant information on the unused transmission occasion to a physical layer of the terminal equipment, which comprises:
for each transmission occasion, notifying the physical layer of the relevant information on the unused transmission occasion.

In some embodiments, the indicating unit 902 indicates relevant information on the unused transmission occasion to a physical layer of the terminal equipment, which comprises:
for a transmission occasion determined to be unused, not notifying the physical layer of the relevant information on the unused transmission occasion.

In some embodiments, the determining unit 901 determines an unused transmission occasion for all transmission occasions within a CG periodicity or a time period or in a predetermined number of transmission occasions, which comprises:
the determining unit 901 determines whether at least one transmission occasion is an unused transmission occasion according to a buffer size and/or traffic pattern.

In some embodiments, the indicating unit 902 indicates relevant information on the unused transmission occasion to a physical layer of the terminal equipment, which comprises:
notifying at one time the physical layer of the relevant information on the unused transmission occasion.

In the above embodiments, the indicating unit 902 notifies at one time the physical layer of the relevant information on the unused transmission occasion within a CG periodicity or a time period or before a predetermined number of transmission occasions.

In some embodiments, the determining unit 901 determines an unused transmission occasion for partial transmission occasions within a CG periodicity or a time period or in a predetermined number of transmission occasions, which comprises:
when new data arrives, for next transmission occasions, determining whether at least one transmission occasion is an unused transmission occasion, and/or, for specific transmission occasions within a CG periodicity or a time period or in a predetermined number of transmission occasions, determining whether at least one transmission occasion is an unused transmission occasion.

In the above embodiments, the indicating unit 902 indicates relevant information on the unused transmission occasion to a physical layer of the terminal equipment, which comprises:
after the determining unit 901 determines an unused transmission occasion, the indicating unit 902 notifies the physical layer of the relevant information on the unused transmission occasion.

In some embodiments, as shown in FIG. 9, the apparatus further comprises a transmitting unit 903, the transmitting unit 903 does not transmit UTO-UCI in an unused transmission occasion.

In some embodiments, the determining unit 901 determines an unused transmission occasion, which further comprises:
the determining unit 901 determines whether a transmission occasion or a valid transmission occasion within a time period or a CG periodicity is an unused transmission occasion; and/or,
the determining unit 901 determines whether a predetermined number of transmission occasions or valid transmission occasions are unused transmission occasions.

In some embodiments, the transmission occasion or the valid transmission occasion is a next transmission occasion after a transmission occasion where the UTO-UCI is located, or is a transmission occasion that starts after an offset value after a transmission occasion where the UTO-UCI is located.

In the above embodiments, a length of the time period or the predetermined number or the offset value is predefined, or is configured by a network.

In the above embodiments, the valid transmission occasion does not overlap with a DL symbol or an SSB under a TDD configuration.

In some embodiments, the relevant information on the unused transmission occasion includes:
whether a transmission occasion or a valid transmission occasion within a time period or a CG periodicity is an unused transmission occasion; and/or,
whether a predetermined number of transmission occasions or valid transmission occasions are unused transmission occasions.

In the above embodiments, the transmission occasion or the valid transmission occasion is a next transmission occasion after a transmission occasion where the UTO-UCI is located, or is a transmission occasion that starts after an offset value after a transmission occasion where the UTO-UCI is located.

In the above embodiments, a length of the time period or the predetermined number or the offset value is predefined, or is configured by a network.

In the above embodiments, the valid transmission occasion does not overlap with a DL symbol or an SSB under a TDD configuration.

In some embodiments, the apparatus further comprises a generating unit 904, and for a specific transmission occasion, the generating unit 904 generates a MAC PDU, the specific transmission occasion including at least one of the following:
a transmission occasion for which a use state is not indicated, and/or, a transmission occasion determined as unused or a transmission occasion at which a MAC layer determines not to generate a MAC PDU,
a transmission occasion for which a use state has been indicated and the use state is NOT unused, and/or, a transmission occasion determined as unused or a transmission occasion at which a MAC layer determines not to generate a MAC PDU,
a transmission occasion in a first time period,
a transmission occasion in a predetermined number of transmission occasions, or
a transmission occasion after a predetermined number of transmission occasions.

In the above embodiments, the transmission occasion in the first time period is a first transmission occasion or a last transmission occasion or one of transmission occasions in the first time period.

In the above embodiments, the transmission occasion in the predetermined number of transmission occasions is a first transmission occasion, a last transmission occasion or one of transmission occasions in the predetermined number of transmission occasions.

In the above embodiments, the transmission occasion after the predetermined number of transmission occasions is a first transmission occasion after the predetermined number of transmission occasions or a first transmission occasion after a first number of offsets after the predetermined number of transmission occasions.

In the above embodiments, the first number of offsets is predefined, or is configured by a network.

In the above embodiments, the first time period is one or more CG periodicities, or the first time period is a predefined time period or a time period configured by a network device, and the predetermined number is predefined, or is configured by a network. Embodiments of the present disclosure do not impose limitations thereto.

In the above embodiments, the MAC PDU generated by the generating unit 904 is at least one of the following:
a MAC PDU including a padding bit;
a MAC PDU including a regular BSR; or
a MAC PDU including a padding BSR.

In some embodiments, the generating unit 904 does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

Embodiments of the present disclosure further provide a generating apparatus, configured to generate a MAC PDU. The apparatus may, for example, be a terminal equipment, or may be one or more parts or components configured in the terminal equipment. The apparatus in the embodiments of the present disclosure corresponds to the method in the embodiments of the second aspect, the contents same as those in the embodiments of the second aspect are not repeated.

FIG. 10 is a schematic diagram of an example of a generating apparatus in the embodiments of the present disclosure. As shown in FIG. 10, the generating apparatus 1000 comprises a generating unit 1001 and a transmitting unit 1002, the generating unit 1001 generating a MAC PDU for a specific transmitting occasion at a MAC layer of the terminal equipment, the transmitting unit 1002 transmitting the MAC PDU to a network device and indicating a use state of the specific transmitting occasion via the MAC PDU, wherein the specific transmitting occasion includes at least one of the following:
a transmission occasion for which a use state is not indicated, and/or, a transmission occasion determined as unused or a transmission occasion at which a MAC layer determines not to generate a MAC PDU,
a transmission occasion for which a use state has been indicated and the use state is NOT unused, and/or, a transmission occasion determined as unused or a transmission occasion at which a MAC layer determines not to generate a MAC PDU,
a transmission occasion in a first time period,
a transmission occasion in a predetermined number of transmission occasions, or
a transmission occasion after a predetermined number of transmission occasions.

In some embodiments, the transmission occasion in the first time period is a first transmission occasion or a last transmission occasion or one of transmission occasions in the first time period.

In some embodiments, the transmission occasion in the predetermined number of transmission occasions is a first transmission occasion, a last transmission occasion or one of transmission occasions in the predetermined number of transmission occasions.

In some embodiments, the transmission occasion after the predetermined number of transmission occasions is a first transmission occasion after the predetermined number of transmission occasions or a first transmission occasion after a first number of offsets after the predetermined number of transmission occasions.

In some embodiments, the first number of offsets is predefined, or is configured by a network.

In some embodiments, the first time period is one or more CG periodicities, or the first time period is a predefined time period or a time period configured by a network device, and the predetermined number is predefined, or is configured by a network.

In some embodiments, the MAC PDU generated by the generating unit 1001 is at least one of the following:
a MAC PDU including a padding bit;
a MAC PDU including a regular BSR; or
a MAC PDU including a padding BSR.

In some embodiments, the generating unit 1001 does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

Embodiments of the present disclosure provide an apparatus for processing MAC PDUs. The apparatus may, for example, be a terminal equipment, or may be one or more parts or components configured in the terminal equipment. The apparatus in the embodiments of the present disclosure corresponds to the method for processing MAC PDUs in the embodiments of the third aspect, the contents same as those in the method for processing MAC PDUs in the embodiments of the third aspect are not repeated.

FIG. 11 is a schematic diagram of an example of an apparatus for processing MAC PDUs in the embodiments of the present disclosure. As shown in FIG. 11, the apparatus 1100 comprises a generating unit 1101, the generating unit 1101 being used to generate a MAC PDU at a MAC layer of a terminal equipment, and the generating unit 1101 does not generate the MAC PDU when at least one of the following first conditions is satisfied and a second condition is satisfied, the first conditions including:
if the specific transmission occasion is indicated as an unused transmission occasion;
if the specific transmission occasion is determined by MAC as a transmission occasion that will not generate a MAC PDU;
if there is no data in any LCG for the specific transmission occasion;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG to be transmitted, or the MAC PDU only includes a padding BSR.

Embodiments of the present disclosure further provide an apparatus for determining End of Data Burst. The apparatus may, for example, be a terminal equipment, or may be one or more parts or components configured in the terminal equipment. The apparatus in the embodiments of the present disclosure corresponds to the method for determining End of Data Burst (EoDB) in the embodiments of the third aspect, the contents same as those in the method for determining End of Data Burst (EoDB) in the embodiments of the third aspect are not repeated.

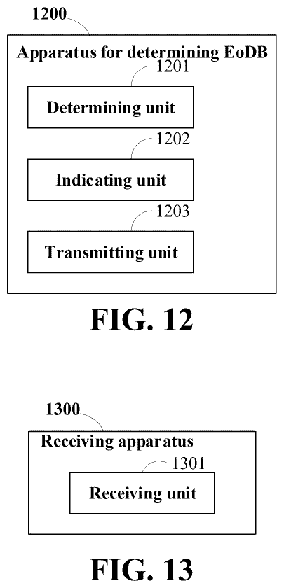

FIG. 12 is a schematic diagram of an example of an apparatus for determining End of Data Burst in the embodiments of the present disclosure. As shown in FIG. 12, the apparatus 1200 comprises a determining unit 1201 and an indicating unit 1202, the determining unit 1201 determining EoDB at a MAC layer of the terminal equipment; and the indicating unit 1202 indicating relevant information on the EoDB to a physical layer of the terminal equipment at the MAC layer of the terminal equipment; wherein the determining unit 1201 determines the EoDB and/or the indicating unit 1202 indicates relevant information on the EoDB in at least one of the following procedures, the procedures including: an uplink grant receiving procedure, a multiplexing and integration procedure or a logical channel priority processing procedure, an HARQ entity operation procedure, or an HARQ process operation procedure.

In some embodiments, the apparatus 1200 further comprises a transmitting unit 1203, the transmitting unit 1203 transmitting uplink control information to the network device at a physical layer of the terminal equipment, wherein the uplink control information is used to indicate the EoDB.

Embodiments of the present disclosure further provide a receiving apparatus, configured to receive a MAC PDU. The device may, for example, be a network device, or may be one or more parts or components configured in the network device. The apparatus in the embodiments of the present disclosure corresponds to the method in the embodiments of the fourth aspect, the contents same as those in the embodiments of the fourth aspect are not repeated.

FIG. 13 is a schematic diagram of an example of a receiving apparatus in the embodiments of the present disclosure. As shown in FIG. 13, the receiving apparatus 1300 in the embodiments of the present disclosure comprises a receiving unit 1301, the receiving unit 1301 receiving a MAC PDU generated by a MAC layer of a terminal equipment for a specific transmission occasion, and receiving indication information of a use state of at least one transmission occasion transmitted by the terminal equipment,
wherein the specific transmission occasion includes at least one of the following:
a transmission occasion for which a use state is not indicated, and/or, a transmission occasion determined as unused or a transmission occasion at which a MAC layer of the terminal equipment determines not to generate a MAC PDU,
a transmission occasion for which a use state has been indicated and the use state is NOT unused, and/or, a transmission occasion determined as unused or a transmission occasion at which a MAC layer of the terminal equipment determines not to generate a MAC PDU,
a transmission occasion in a first time period,
a transmission occasion in a predetermined number of transmission occasions, or
a transmission occasion after a predetermined number of transmission occasions.

In some embodiments, the indication information transmitted by the terminal equipment is UTO-UCI. That is, the terminal equipment indicates a use state of the at least one CGO to the network device via UTO-UCI, the UTO-UCI being transmitted in a PUSCH corresponding to a specific transmission occasion, that is, the UTO-UCI is transmitted in a PUSCH resource corresponding to a CGO where the generated MAC PDU is located, thereby the receiving unit 1301 receives the indication information in corresponding resources.

In some embodiments, the transmission occasion in the first time period is a first transmission occasion or a last transmission occasion or one of transmission occasions in the first time period.

In some embodiments, the transmission occasion in the predetermined number of transmission occasions is a first transmission occasion, a last transmission occasion or one of transmission occasions in the predetermined number of transmission occasions.

In some embodiments, the transmission occasion after the predetermined number of transmission occasions is a first transmission occasion after the predetermined number of transmission occasions or a first transmission occasion after a first number of offsets after the predetermined number of transmission occasions.

In some embodiments, the first number of offsets is predefined, or is configured by a network.

In some embodiments, the first time period is one or more CG periodicities, or the first time period is a predefined time period or a time period configured by a network device, and the predetermined number is predefined, or is configured by a network. Embodiments of the present disclosure do not impose limitations thereto.

In some embodiments, the MAC PDU generated by the MAC layer of the terminal equipment, as received by the receiving unit 1301, is at least one of the following:
a MAC PDU including a padding bit;
a MAC PDU including a regular BSR; or
a MAC PDU including a padding BSR.

In some embodiments, the MAC layer of the terminal equipment does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

It's worth noting that the above only describes components or modules related to the present disclosure, but the present disclosure is not limited thereto. Apparatuses 900 to 1300 in the embodiments of the present disclosure may further comprise other components or modules. For detailed contents of these components or modules, relevant technologies may be referred to. Moreover, the above components or modules may be realized by a hardware facility such as a processor, a memory, a transmitter, a receiver, etc. The embodiments of the present disclosure have no limitation thereto.

According to the apparatuses in the embodiments of the present disclosure, during a process of transmitting uplink data, a terminal equipment determines an unused transmission occasion via a MAC layer and indicates relevant information on the unused transmission occasion to a physical layer, thereby the terminal equipment may inform a network device of the relevant information on the unused transmission occasion. As a result, the network device may rationally allocate uplink resources according to the relevant information on the unused transmission occasion, which reduces resource waste.

### Embodiments of a Sixth Aspect

Embodiments of the present disclosure further provide a communication system, comprising a network device and a terminal equipment.

In the embodiments of the present disclosure, the terminal equipment comprises the apparatus shown in FIG. 9 in the embodiments of the fifth aspect, configured to perform the method in the embodiments of the first aspect. Since each method has been described in details in the embodiments of the first aspect, its contents are incorporated here and are not repeated.

In the embodiments of the present disclosure, the network device comprises the apparatus shown in FIG. 13 in the embodiments of the fifth aspect, configured to perform the method in the embodiments of the fourth aspect. Since each method has been described in details in the embodiments of the fourth aspect, its contents are incorporated here and are not repeated. In addition, the network device performs normal operations of the network device, and the network device may further perform operations corresponding to the operations of the terminal equipment, for example the network device receives information/signals from the terminal equipment, and/or the network device transmits information/signals to the terminal equipment, descriptions are omitted here.

Embodiments of the present disclosure further provide a terminal equipment, the terminal equipment for example may be a UE, but the present disclosure is not limited to this, it may also be other terminal equipment.

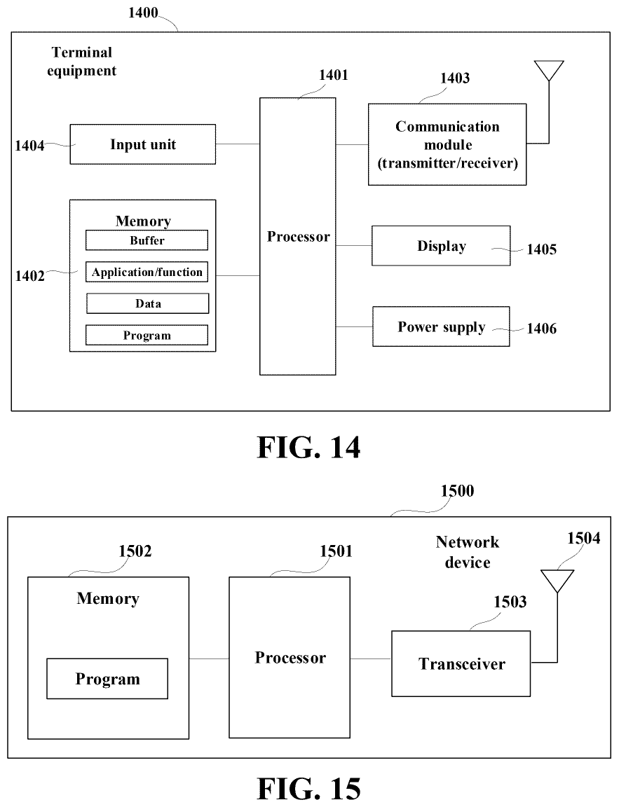

FIG. 14 is a schematic diagram of a terminal equipment in the embodiments of the present disclosure. As shown in FIG. 14, the terminal equipment 1400 may comprise a processor 1401 and a memory 1402; the memory 1402 stores data and programs, and is coupled to the processor 1401. It's worth noting that this figure is exemplary; other types of structures may also be used to supplement or replace this structure, so as to realize a telecommunication function or other functions.

In some embodiments, functions of the apparatus 900 in the embodiments of the fifth aspect may be integrated into the processor 1401, wherein the processor 1401 may be configured to execute a program to implement the method as described in the embodiments of the first aspect, the contents of which are incorporated herein and are not described repeatedly here.

In some other embodiments, the apparatus 900 in the embodiments of the fifth aspect may be configured separately from the processor 1401, for example the apparatus 900 in the embodiments of the fifth aspect may be configured as a chip connected to the processor 1401, functions of the apparatus 900 in the embodiments of the fifth aspect are implemented through the control of the processor 1301.

As shown in FIG. 14, the terminal equipment 1400 may further comprise: a communication module 1403, an input unit 1404, a display 1405 and a power supply 1406. The functions of said components are similar to related arts, which are not repeated here. It's worth noting that the terminal equipment 1400 does not have to include all the components shown in FIG. 14, said components are not indispensable. Moreover, the terminal equipment 1400 may also include components not shown in FIG. 14, relevant technologies may be referred to.

Embodiments of the present disclosure further provide a network device, the network device for example may be a base station, but the present disclosure is not limited to this, it may also be other network device.

FIG. 15 is a schematic diagram of a network device in the embodiments of the present disclosure. As shown in FIG. 15, the network device 1500 may comprise: a processor 1501 and a memory 1502; the memory 1502 is coupled to the processor 1501. The memory 1502 may store various data; moreover, also stores a program for information processing, and executes the program under the control of the processor 1501.

In some embodiments, functions of the apparatus 1300 in the embodiments of the fifth aspect may be integrated into the processor 1501, wherein the processor 1501 may be configured to execute a program to implement the method as described in the embodiments of the fourth aspect, the contents of which are incorporated herein and are not described repeatedly here.

In some other embodiments, the apparatus 1300 in the embodiments of the fifth aspect may be configured separately from the processor 1501, for example the apparatus 1300 in the embodiments of the fifth aspect may be configured as a chip connected to the processor 1501, functions of the apparatus 1300 in the embodiments of the fifth aspect are implemented through the control of the processor 1501.

In addition, as shown in FIG. 15, the network device 1500 may further comprise: transceivers 1503 and 1504. The functions of said components are similar to related arts, which are not repeated here. It's worth noting that the network device 1500 does not have to include all the components shown in FIG. 15. Moreover, the network device 1500 may also include components not shown in FIG. 15, relevant arts can be referred to.

Embodiments of the present disclosure further provide a computer program, wherein when a terminal equipment executes the program, the program enables the terminal equipment to execute the method described in the embodiments of the first aspect.

Embodiments of the present disclosure further provide a storage medium in which a computer program is stored, wherein the computer program enables a terminal equipment to execute the method described in the embodiments of the first aspect.

Embodiments of the present disclosure further provide a computer program, wherein when a network device executes the program, the program enables the network device to execute the method described in the embodiments of the fourth aspect.

Embodiments of the present disclosure further provide a storage medium in which a computer program is stored, wherein the computer program enables a network device to execute the method described in the embodiments of the fourth aspect.

The apparatuses and methods in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

As for the implementations including the above embodiments, the following supplements are further disclosed:

1. A method for indicating unused transmission occasions, applied to a terminal equipment, wherein the method includes:
a MAC layer of the terminal equipment determines an unused transmission occasion; and
the MAC layer of the terminal equipment indicates relevant information on the unused transmission occasion to a physical layer of the terminal equipment;
wherein the MAC layer of the terminal equipment determines the unused transmission occasion and/or indicates relevant information on the unused transmission occasion in at least one of the following procedures, the procedures including: an uplink grant receiving procedure, a multiplexing and integration procedure or a logical channel priority processing procedure, an HARQ entity operation procedure, or an HARQ process operation procedure.

2. The method according to supplement 1, wherein,
the physical layer transmits uplink control information (UTO-UCI) in a not-unused transmission occasion, wherein the uplink control information is used to indicate unused transmission occasions.

3. The method according to supplement 1, wherein,
the MAC layer of the terminal equipment determines the unused transmission occasion and/or indicates relevant information on the unused transmission occasion in the uplink grant receiving procedure, which include(s):
the MAC layer of the terminal equipment determines the unused transmission occasion and/or indicates relevant information on the unused transmission occasion after determining that a PUSCH duration of a transmission occasion does not overlap with a PUSCH duration of an uplink grant received in an RAR or a PUSCH duration addressed to a temporary C-RNTI or a PUSCH duration of a MSGA payload; or,
the MAC layer of the terminal equipment determines the unused transmission occasion and/or indicates relevant information on the unused transmission occasion after determining that a PUSCH duration of a transmission occasion does not overlap with a PUSCH duration of an uplink grant received on a PDCCH or a PUSCH duration of an uplink grant received in an RAR or a PUSCH duration addressed to a temporary C-RNTI or a PUSCH duration of a MSGA payload; or,
the MAC layer of the terminal equipment determines the unused transmission occasion and/or indicates relevant information on the unused transmission occasion after delivering a transmission occasion or a configured uplink grant and associated HARQ information to an HARQ entity; or,
the MAC layer of the terminal equipment determines the unused transmission occasion and/or indicates relevant information on the unused transmission occasion after considering that an uplink grant corresponding to a transmission occasion is a prioritized uplink grant.

4. The method according to supplement 1, wherein,
the MAC layer of the terminal equipment determines the unused transmission occasion and/or indicates relevant information on the unused transmission occasion in the multiplexing and integration procedure or the logical channel priority processing procedure, which include(s):
the MAC layer of the terminal equipment determines the unused transmission occasion and/or indicates relevant information on the unused transmission occasion after selecting a logical channel for uplink grant transmission of a transmission occasion; or,
the MAC layer of the terminal equipment determines the unused transmission occasion and/or indicates relevant information on the unused transmission occasion after allocating resources for a logical channel; or,
the MAC layer of the terminal equipment determines the unused transmission occasion and/or indicates relevant information on the unused transmission occasion after determining to generate a MAC PDU for an HARQ entity; or,
the MAC layer of the terminal equipment determines the unused transmission occasion and/or indicates relevant information on the unused transmission occasion after determining not to generate a MAC PDU for an HARQ entity; or,
the MAC layer of the terminal equipment determines the unused transmission occasion and/or indicates relevant information on the unused transmission occasion after multiplexing a MAC CE and/or MAC SDU to a MAC PDU.

5. The method according to supplement 1, wherein,
the MAC layer of the terminal equipment determines the unused transmission occasion and/or indicates relevant information on the unused transmission occasion in the HARQ entity operation procedure, which include(s):
the MAC layer of the terminal equipment determines the unused transmission occasion and/or indicates relevant information on the unused transmission occasion after identifying an HARQ process associated with an uplink grant of a CGO; or,
the MAC layer of the terminal equipment determines the unused transmission occasion and/or indicates relevant information on the unused transmission occasion after a MAC PDU is obtained; or,
the MAC layer of the terminal equipment determines the unused transmission occasion and/or indicates relevant information on the unused transmission occasion after delivering a MAC PDU, an uplink grant and HARQ information to an identified HARQ process; or,
the MAC layer of the terminal equipment determines the unused transmission occasion and/or indicates relevant information on the unused transmission occasion after indicating an identified HARQ process to trigger a new transmission; or,
the MAC layer of the terminal equipment determines the unused transmission occasion and/or indicates relevant information on the unused transmission occasion after starting or restarting configuredGrantTimer.

6. The method according to supplement 1, wherein,
the MAC layer of the terminal equipment determines the unused transmission occasion and/or indicates relevant information on the unused transmission occasion in the HARQ process operation procedure, which include(s):
the MAC layer of the terminal equipment determines the unused transmission occasion and/or indicates relevant information on the unused transmission occasion after an HARQ process generates a transmission; or,
the MAC layer of the terminal equipment determines the unused transmission occasion and/or indicates relevant information on the unused transmission occasion after indicating a physical layer to generate a transmission according to an uplink grant.

7. The method according to supplement 1, wherein the MAC layer of the terminal equipment determines an unused transmission occasion, which includes at least one of the following:
the MAC layer of the terminal equipment determines an unused transmission occasion, for each transmission occasion;
the MAC layer of the terminal equipment determines an unused transmission occasion for all transmission occasions within a configured grant (CG) periodicity or a time period or in a predetermined number of transmission occasions; or
the MAC layer of the terminal equipment determines an unused transmission occasion for partial transmission occasions within a CG periodicity or a time period or in a predetermined number of transmission occasions.

8. The method according to supplement 7, wherein the MAC layer of the terminal equipment determines an unused transmission occasion for each transmission occasion, which includes:
the MAC layer of the terminal equipment determines whether at least one transmission occasion is an unused transmission occasion according to a current buffer size and/or traffic pattern.

9. The method according to supplement 1 or 7 or 8, wherein the MAC layer of the terminal equipment indicates relevant information on the unused transmission occasion to a physical layer of the terminal equipment, which includes:
for each transmission occasion, the MAC layer of the terminal equipment notifies the physical layer of the relevant information on the unused transmission occasion.

10. The method according to supplement 1 or 7 or 8, wherein the MAC layer of the terminal equipment indicates relevant information on the unused transmission occasion to a physical layer of the terminal equipment, which includes:
for a transmission occasion determined to be unused, the MAC layer of the terminal equipment does not notify the physical layer of the relevant information on the unused transmission occasion.

11. The method according to supplement 7, wherein the MAC layer of the terminal equipment determines an unused transmission occasion for all transmission occasions within a CG periodicity or a time period or in a predetermined number of transmission occasions, which includes:
the MAC layer of the terminal equipment determines whether at least one transmission occasion is an unused transmission occasion according to a buffer size and/or traffic pattern.

12. The method according to supplement 1 or 7 or 11, wherein the MAC layer of the terminal equipment indicates relevant information on the unused transmission occasion to a physical layer of the terminal equipment, which includes:
the MAC layer of the terminal equipment notifies at one time the physical layer of the relevant information on the unused transmission occasion.

13. The method according to supplement 12, wherein,
the MAC layer of the terminal equipment notifies at one time the physical layer of the relevant information on the unused transmission occasion within a CG periodicity or a time period or before a predetermined number of transmission occasions.

14. The method according to supplement 7, wherein the MAC layer of the terminal equipment determines an unused transmission occasion for partial transmission occasions within a CG periodicity or a time period or in a predetermined number of transmission occasions, which includes:
when new data arrives, for next transmission occasions, the MAC layer of the terminal equipment determines whether at least one transmission occasion is an unused transmission occasion, and/or, for specific transmission occasions within a CG periodicity or a time period or in a predetermined number of transmission occasions, the MAC layer of the terminal equipment determines whether at least one transmission occasion is an unused transmission occasion.

15. The method according to supplement 14, wherein the specific transmission occasion includes a first transmission occasion or a Kth transmission occasion or a last transmission occasion or Jth to Lth transmission occasions within a CG periodicity or a time period or in a predetermined number of transmission occasions, where K is an integer greater than 1, J and L are positive integers and L is greater than M.

16. The method according to supplement 14, wherein the MAC layer of the terminal equipment indicates relevant information on the unused transmission occasion to a physical layer of the terminal equipment, which includes:
after the unused transmission occasion is determined, the MAC layer of the terminal equipment notifies the physical layer of the relevant information on the unused transmission occasion.

17. The method according to any one of supplements 7 to 16, wherein the method further includes:
the MAC layer of the terminal equipment does not transmit UTO-UCI in an unused transmission occasion.

18. The method according to any one of supplements 7 to 17, wherein the MAC layer of the terminal equipment determines an unused transmission occasion, which further includes:
the terminal equipment determines whether a transmission occasion or a valid transmission occasion within a time period or a CG periodicity is an unused transmission occasion; and/or,
the terminal equipment determines whether a predetermined number of transmission occasions or valid transmission occasions are unused transmission occasions.

19. The method according to supplement 18, wherein,
the transmission occasion or the valid transmission occasion is a next transmission occasion after a transmission occasion where the UTO-UCI is located, or is a transmission occasion that starts after an offset value after a transmission occasion where the UTO-UCI is located.

20. The method according to supplement 18, wherein,
a length of the time period or the predetermined number or the offset value is predefined, or is configured by a network.

21. The method according to any one of supplements 18-20, wherein,
the valid transmission occasion does not overlap with a DL symbol or an SSB under a TDD configuration.

22. The method according to any one of supplements 1-21, wherein,
the relevant information on the unused transmission occasion includes:
whether a transmission occasion or a valid transmission occasion within a time period or a CG periodicity is an unused transmission occasion; and/or,
whether a predetermined number of transmission occasions or valid transmission occasions are unused transmission occasions.

23. The method according to supplement 22, wherein,
the transmission occasion or the valid transmission occasion is a next transmission occasion after a transmission occasion where the UTO-UCI is located, or is a transmission occasion that starts after an offset value after a transmission occasion where the UTO-UCI is located.

24. The method according to supplement 23, wherein,
a length of the time period or the predetermined number or the offset value is predefined, or is configured by a network.

25. The method according to any one of supplements 22-24, wherein,
the valid transmission occasion does not overlap with a DL symbol or an SSB under a TDD configuration.

26. The method according to any one of supplements 1-25, wherein the method further includes:
for a specific transmission occasion, the MAC layer of the terminal equipment generates a MAC PDU, the specific transmission occasion including at least one of the following:
a transmission occasion for which a use state is not indicated, and/or, a transmission occasion determined as unused or a transmission occasion at which a MAC layer determines not to generate a MAC PDU,
a transmission occasion for which a use state has been indicated and the use state is NOT unused, and/or, a transmission occasion determined as unused or a transmission occasion at which a MAC layer determines not to generate a MAC PDU,
a transmission occasion in a first time period,
a transmission occasion in a predetermined number of transmission occasions, or
a transmission occasion after a predetermined number of transmission occasions.

27. The method according to supplement 26, wherein,
the transmission occasion in the first time period is a first transmission occasion or a last transmission occasion or one of transmission occasions in the first time period.

28. The method according to supplement 26, wherein,
the transmission occasion in the predetermined number of transmission occasions is a first transmission occasion, a last transmission occasion or one of transmission occasions in the predetermined number of transmission occasions.

29. The method according to supplement 26, wherein,
the transmission occasion after the predetermined number of transmission occasions is a first transmission occasion after the predetermined number of transmission occasions or a first transmission occasion after a first number of offsets after the predetermined number of transmission occasions.

30. The method according to supplement 29, wherein,
the first number of offsets is predefined, or is configured by a network.

31. The method according to any one of supplements 26-30, wherein,
the first time period is one or more CG periodicities, or the first time period is a predefined time period or a time period configured by a network device, and
the predetermined number is predefined, or is configured by a network.

32. The method according to supplement 25, wherein the MAC PDU generated by the MAC layer of the terminal equipment is at least one of the following:
a MAC PDU including a padding bit;
a MAC PDU including a regular BSR; or
a MAC PDU including a padding BSR.

33. The method according to supplement 26, wherein,
a MAC layer of the terminal equipment does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

34. A method for generating MAC PDUs, applied to a terminal equipment, wherein the method includes:
a MAC layer of the terminal equipment generates a MAC PDU for a specific transmission occasion,
wherein the specific transmission occasion includes at least one of the following:
a transmission occasion for which a use state is not indicated, and/or, a transmission occasion determined as unused or a transmission occasion at which a MAC layer determines not to generate a MAC PDU,
a transmission occasion for which a use state has been indicated and the use state is NOT unused, and/or, a transmission occasion determined as unused or a transmission occasion at which a MAC layer determines not to generate a MAC PDU,
a transmission occasion in a first time period,
a transmission occasion in a predetermined number of transmission occasions,
a transmission occasion after a predetermined number of transmission occasions, or
the terminal equipment transmits the MAC PDU to a network device, and indicate a use state of at least one transmission occasion to the network device.

35. The method according to supplement 34, wherein,
the transmission occasion in the first time period is a first transmission occasion or a last transmission occasion or one of transmission occasions in the first time period.

36. The method according to supplement 34, wherein,
the transmission occasion in the predetermined number of transmission occasions is a first transmission occasion, a last transmission occasion or one of transmission occasions in the predetermined number of transmission occasions.

37. The method according to supplement 34, wherein,
the transmission occasion after the predetermined number of transmission occasions is a first transmission occasion after the predetermined number of transmission occasions or a first transmission occasion after a first number of offsets after the predetermined number of transmission occasions.

38. The method according to supplement 37, wherein,
the first number of offsets is predefined, or is configured by a network.

39. The method according to any one of supplements 34-37, wherein,
the first time period is one or more CG periodicities, or the first time period is a predefined time period or a time period configured by a network device, and
the predetermined number is predefined, or is configured by a network.

40. The method according to supplement 34, wherein the MAC PDU generated by the MAC layer of the terminal equipment is at least one of the following:
a MAC PDU including a padding bit;
a MAC PDU including a regular BSR; or
a MAC PDU including a padding BSR.

41. The method according to supplement 34, wherein,
a MAC layer of the terminal equipment does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

42. A method for processing MAC PDUs, applied to a terminal equipment, wherein the method includes:
a MAC layer of the terminal equipment does not generate the MAC PDU when at least one of the following first conditions is satisfied and a second condition is satisfied, the first conditions including:
if a specific transmission occasion is indicated as an unused transmission occasion;
if the specific transmission occasion is determined by MAC as a transmission occasion that will not generate a MAC PDU;
if there is no data in any LCG for the specific transmission occasion;
if there is no UTO-UCI to be transmitted;
if the specific transmission occasion is not a first transmission occasion or a last transmission occasion or one of them within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG to be transmitted, or the MAC PDU only includes a padding BSR.

43. A method for determining End of Data Burst (EoDB), applied to a terminal equipment, wherein the method includes:
a MAC layer of the terminal equipment determines EoDB; and
the MAC layer of the terminal equipment indicates relevant information on the EoDB to a physical layer of the terminal equipment;
wherein, the MAC layer of the terminal equipment determines the EoDB and/or indicates relevant information on the EoDB in at least one of the following procedures, the procedures including: an uplink grant receiving procedure, a multiplexing and integration procedure or a logical channel priority processing procedure, an HARQ entity operation procedure, or an HARQ process operation procedure.

44. The method according to supplement 43, wherein the method further includes:
the physical layer of the terminal equipment transmits uplink control information to the network device, wherein the uplink control information is used to indicate the EoDB.

45. A method for receiving MAC PDUs, applied to a network device, wherein the method includes:
the network device receives a MAC PDU generated by a MAC layer of a terminal equipment for a specific transmission occasion, and receive indication information on a use state of at least one transmission occasion transmitted by the terminal equipment,
wherein the specific transmission occasion includes at least one of the following:
a transmission occasion for which a use state is not indicated, and/or, a transmission occasion determined as unused or a transmission occasion at which a MAC layer of the terminal equipment determines not to generate a MAC PDU,
a transmission occasion for which a use state has been indicated and the use state is NOT unused, and/or, a transmission occasion determined as unused or a transmission occasion at which a MAC layer of the terminal equipment determines not to generate a MAC PDU,
a transmission occasion in a first time period,
a transmission occasion in a predetermined number of transmission occasions, or
a transmission occasion after a predetermined number of transmission occasions.

46. The method according to supplement 45, wherein,
the transmission occasion in the first time period is a first transmission occasion or a last transmission occasion or one of transmission occasions in the first time period.

47. The method according to supplement 45, wherein,
the transmission occasion in the predetermined number of transmission occasions is a first transmission occasion, a last transmission occasion or one of transmission occasions in the predetermined number of transmission occasions.

48. The method according to supplement 45, wherein,
the transmission occasion after the predetermined number of transmission occasions is a first transmission occasion after the predetermined number of transmission occasions or a first transmission occasion after a first number of offsets after the predetermined number of transmission occasions.

49. The method according to supplement 48, wherein,
the first number of offsets is predefined, or is configured by a network.

50. The method according to any one of supplements 45-48, wherein,
the first time period is one or more CG periodicities, or the first time period is a predefined time period or a time period configured by a network device, and
the predetermined number is predefined, or is configured by a network.

51. The method according to supplement 45, wherein the MAC PDU generated by the MAC layer of the terminal equipment is at least one of the following:
a MAC PDU including a padding bit;
a MAC PDU including a regular BSR; or
a MAC PDU including a padding BSR.

52. The method according to supplement 45, wherein,
a MAC layer of the terminal equipment does not generate the MAC PDU when at least one of the following first conditions is satisfied and a second condition is satisfied, the first conditions including:
if the specific transmission occasion is not a transmission occasion whose use state has not been indicated and which is determined by the MAC layer that no MAC PDU will be generated;
if the specific transmission occasion is not a transmission occasion which has been indicated as NOT unused and is determined by the MAC layer that no MAC PDU will be generated;
if there is no UTO-UCI to be transmitted;
if the specific transmission occasion is not a first transmission occasion or a last transmission occasion or one of transmission occasions within a first time period;
if the specific transmission occasion is not a first transmission occasion, a last transmission occasion or one of transmission occasions among a predetermined number of transmission occasions; or
if the specific transmission occasion is not a first transmission occasion after the predetermined number of transmission occasions or a first transmission occasion after a first offset value after the predetermined number of transmission occasions,
and the second condition includes at least one of the following:
if there is no aperiodic CSI for a specified PUSCH transmission request;
if the MAC PDU includes zero MAC SDU; or
if the MAC PDU only includes a periodic BSR and there is no data in any LCG, or the MAC PDU only includes a padding BSR.

53. A terminal equipment, comprising a memory and a processor, the memory storing a computer program, and the processor being configured to execute the computer program to implement the method according to any one of supplements 1-44.

54. A network device, comprising a memory and a processor, the memory storing a computer program, and the processor being configured to execute the computer program to implement the method according to any one of supplements 45-53.

55. A communication system, comprising the network device according to supplement 54 and the terminal equipment according to supplement 53.

What is claimed is:

1. An indicating apparatus, configured to indicate unused transmission occasions, configured in a terminal equipment, the apparatus comprising:
determining processor circuitry configured to determine an unused transmission occasion at a media access control layer of the terminal equipment; and
indicating processor circuitry configured to indicate relevant information on the unused transmission occasion to a physical layer of the terminal equipment via the media access control layer of the terminal equipment;
wherein the determining processor circuitry determines whether a transmission occasion in a predetermined number of valid transmission occasions is an unused transmission occasion.

2. The apparatus according to claim 1, wherein,
the indicating processor circuitry further indicates the physical layer to transmit uplink control information (UTO-UCI) in a not unused transmission occasion, wherein the uplink control information is used to indicate unused transmission occasions.

3. The apparatus according to claim 1, wherein,
in the uplink grant receiving process, the determining processor circuitry determines the unused transmission occasion and/or the indicating processor circuitry indicates relevant information on the unused transmission occasion, comprising:
after determining that a PUSCH (Physical Uplink Shared Channel) duration of a transmission occasion does not overlap with a PUSCH duration of an uplink grant received in a random access response or a PUSCH duration addressed to a temporary C-RNTI (cell radio network temporary identifier) or a PUSCH duration of a message A payload (MSGA payload), the media access control layer of the terminal equipment determines the unused transmission occasion and/or indicates relevant information on the unused transmission occasion; or,
after determining that a PUSCH duration of a transmission occasion does not overlap with a PUSCH duration of an uplink grant received on a PDCCH (Physical Downlink Control Channel) or a PUSCH duration of an uplink grant received in a random access response or a PUSCH duration addressed to a temporary C-RNTI or a PUSCH duration of a message A payload (MSGA payload), the media access control layer of the terminal equipment determines the unused transmission occasion and/or indicates relevant information on the unused transmission occasion; or,
after delivering a transmission occasion or a configured uplink grant and associated HARQ (Hybrid Automatic Repeat Request) information to an HARQ entity, the media access control layer of the terminal equipment determines the unused transmission occasion and/or indicates relevant information on the unused transmission occasion; or,
after considering that an uplink grant corresponding to a transmission occasion is a prioritized uplink grant, the media access control layer of the terminal equipment determines the unused transmission occasion and/or indicates relevant information on the unused transmission occasion.

4. The apparatus according to claim 1, wherein,
in the multiplexing and integration process or the logical channel priority processing process, the determining processor circuitry determines the unused transmission occasion and/or the indicating processor circuitry indicates relevant information on the unused transmission occasion, comprising:
after selecting a logical channel for uplink grant transmission of a transmission occasion, the media access control layer of the terminal equipment determines the unused transmission occasion and/or indicates relevant information on the unused transmission occasion; or,
after allocating resources for a logical channel, the media access control layer of the terminal equipment determines the unused transmission occasion and/or indicates relevant information on the unused transmission occasion; or,
after determining to generate a media access control PDU (Protocol Data Unit) for an HARQ entity, the media access control layer of the terminal equipment determines the unused transmission occasion and/or indicates relevant information on the unused transmission occasion; or,
after determining not to generate a media access control protocol data unit for an HARQ entity, the media access control layer of the terminal equipment determines the unused transmission occasion and/or indicates relevant information on the unused transmission occasion; or,
after multiplexing a media access control control element and/or a media access control service data unit to a media access control protocol data unit, the media access control layer of the terminal equipment determines the unused transmission occasion and/or indicates relevant information on the unused transmission occasion.

5. The apparatus according to claim 1, wherein,
in the HARQ entity operation process, the determining processor circuitry determines the unused transmission occasion and/or the indicating processor circuitry indicates relevant information on the unused transmission occasion, comprising:
after identifying an HARQ process associated with an uplink grant of a transmission occasion, the media access control layer of the terminal equipment determines the unused transmission occasion and/or indicates relevant information on the unused transmission occasion; or,
after a media access control protocol data unit is obtained, the media access control layer of the terminal equipment determines the unused transmission occasion and/or indicates relevant information on the unused transmission occasion; or,
after delivering a media access control protocol data unit and an uplink grant and HARQ information to an identified HARQ process, the media access control layer of the terminal equipment determines the unused transmission occasion and/or indicates relevant information on the unused transmission occasion; or,
after indicating an identified HARQ process to trigger a new transmission, the media access control layer of the terminal equipment determines the unused transmission occasion and/or indicates relevant information on the unused transmission occasion; or,
after starting or restarting a configuredGrantTimer, the media access control layer of the terminal equipment determines the unused transmission occasion and/or indicates relevant information on the unused transmission occasion.

6. The apparatus according to claim 1, wherein,
in the HARQ process operation process, the determining processor circuitry determines the unused transmission occasion and/or the indicating processor circuitry indicates relevant information on the unused transmission occasion, comprising:
after an HARQ process generates a transmission, the media access control layer of the terminal equipment determines the unused transmission occasion and/or indicates relevant information on the unused transmission occasion; or,
after indicating a physical layer to generate a transmission according to an uplink grant, the media access control layer of the terminal equipment determines the unused transmission occasion and/or indicates relevant information on the unused transmission occasion.

7. The apparatus according to claim 1, wherein that the determining processor circuitry determines the unused transmission occasion comprises at least one of the following:
determining an unused transmission occasion for each transmission occasion;
determining an unused transmission occasion for all transmission occasions within a configured grant periodicity or a time period or in a predetermined number of transmission occasions; or
determining an unused transmission occasion for partial transmission occasions within a configured grant periodicity or a time period or in a predetermined number of transmission occasions.

8. The apparatus according to claim 7, wherein that the determining processor circuitry determines the unused transmission occasion for each transmission occasion comprising:
the determining processor circuitry determines whether at least one transmission occasion is an unused transmission occasion according to a buffer size.

9. The apparatus according to claim 8, wherein that the indicating processor circuitry indicates relevant information on the unused transmission occasion to a physical layer of the terminal equipment comprises:
for each transmission occasion, notifying the physical layer of the relevant information on the unused transmission occasion.

10. The apparatus according to claim 8, wherein that the indicating processor circuitry indicates relevant information on the unused transmission occasion to a physical layer of the terminal equipment comprises:
for a transmission occasion determined to be unused, not notifying the physical layer of the relevant information on the unused transmission occasion.

11. The apparatus according to claim 7, wherein that the determining processor circuitry determines the unused transmission occasion for all transmission occasions within a configured grant periodicity or a time period or in a predetermined number of transmission occasions comprising:
the determining processor circuitry determines whether at least one transmission occasion is an unused transmission occasion according to a buffer size.

12. The apparatus according to claim 11, wherein that the indicating processor circuitry indicates relevant information on the unused transmission occasion to a physical layer of the terminal equipment comprises:
notifying at one time the physical layer of the relevant information on the unused transmission occasion.

13. The apparatus according to claim 12, wherein,
the indicating processor circuitry notifies at one time the physical layer of the relevant information on the unused transmission occasion within a configured grant periodicity or a time period or before a predetermined number of transmission occasions.

14. The apparatus according to claim 7, wherein that the determining processor circuitry determines the unused transmission occasion for partial transmission occasions within a configured grant periodicity or a time period or in a predetermined number of transmission occasions comprising:
when new data arrives, for next transmission occasions, determining whether at least one transmission occasion is an unused transmission occasion, and/or, for specific transmission occasions within a configured grant periodicity or a time period or in a predetermined number of transmission occasions, determining whether at least one transmission occasion is an unused transmission occasion.

15. The apparatus according to claim 14, wherein that the indicating processor circuitry indicates relevant information on the unused transmission occasion to a physical layer of the terminal equipment comprising:
after the determining processor circuitry determines the unused transmission occasion, the indicating processor circuitry notifies the physical layer of the relevant information on the unused transmission occasion.

16. The apparatus according to claim 7, the apparatus further comprising:
a transmitter configured not to transmit uplink control information (UTO-UCI) in an unused transmission occasion.

17. The apparatus according to claim 7, wherein that the determining processor circuitry determines the unused transmission occasion further comprising:
the determining processor circuitry determines whether a transmission occasion or a valid transmission occasion within a time period or a configured grant periodicity is an unused transmission occasion; and/or
the determining processor circuitry determines whether a predetermined number of transmission occasions or valid transmission occasions are unused transmission occasions.

18. The apparatus according to claim 17, wherein,
the transmission occasion or the valid transmission occasion is a next transmission occasion after a transmission occasion where uplink control information (UTO-UCI) is located, or is a transmission occasion that starts after an offset value after a transmission occasion where the uplink control information (UTO-UCI) is located.

19. The apparatus according to claim 1, wherein,
the predetermined number is configured by a network device.

20. The apparatus according to claim 1, wherein,
the relevant information on the unused transmission occasion comprises:
whether a transmission occasion or a valid transmission occasion within a time period or a configured grant periodicity is an unused transmission occasion; and/or,
whether a predetermined number of transmission occasions or valid transmission occasions are unused transmission occasions.
